(19) United States
(12) Patent Application Publication
(10) Pub. No.: US 2024/0264543 A1
(43) Pub. Date: Aug. 8, 2024

(54) TONER

(71) Applicant: CANON KABUSHIKI KAISHA, Tokyo (JP)

(72) Inventors: KOSUKE FUKUDOME, Tokyo (JP); TOMOHISA SANO, Shizuoka (JP); TOHRU HIRAMATSU, Shizuoka (JP); ATSUHIKO OHMORI, Kanagawa (JP); HIROKI KAGAWA, Shizuoka (JP); KAZUYUKI SATO, Kanagawa (JP)

(21) Appl. No.: 18/418,622

(22) Filed: Jan. 22, 2024

(30) Foreign Application Priority Data
Jan. 26, 2023 (JP) 2023-010018

(51) Int. Cl. G03G 9/09

(52) U.S. Cl. CPC G03G 9/0902

(57) ABSTRACT

An object of the present invention is to provide a toner that is satisfactory in a charge rising property of the toner and contamination resistance of a charging roller, and can output an image having high density uniformity of a solid image and also having high uniformity of a halftone image, even when having been subjected to the long-term durable use in a low-temperature and low-humidity environment. A toner comprises: a toner particle comprising a binder resin; and a strontium titanate particle, wherein in TOF-SIMS measurement of the toner particle, a fragment peak derived from a boron atom and a fragment peak derived from a boron-oxygen structure are detected, and a fatty acid exists on a surface of the strontium titanate particle.

### BACKGROUND OF THE INVENTION

### Field of the Invention

The present invention relates to a toner used in an electrophotographic image forming apparatus.

### Description of the Related Art

In an electrophotographic image forming apparatus, there is a demand for a higher speed, a smaller size and a longer life. In order to enable the demands, further improvement in various performances is required also for a toner.

For example, when the toner has a satisfactory charge rising property (such a property that the charge amount of the toner increases in a short time), the toner can contribute to the higher speed, the smaller size and the longer life of the electrophotographic image forming apparatus. Specifically, when the charge rising property is satisfactory, the number of parts for assisting the charging of the toner can be reduced, and accordingly, the toner can contribute to the smaller size. In addition, the electrostatic chargeability is enhanced in a short time, which can also contribute to the higher speed. In addition, the toner can easily maintain its electrostatic chargeability even after long-term durable use, and accordingly can contribute also to the longer life.

Conventionally, as a technique for enhancing charge rising property of a toner, a technique of external addition of a strontium titanate particle to a toner particle has been proposed in order to enhance electrostatic chargeability of a toner (Japanese Patent Application Laid-Open No. 2019-045578). It is certain that the charge rising property of the toner can be enhanced by the external addition of the strontium titanate particle, but on the contrary, when the toner is subjected to the long-term durable use under a low-temperature and low-humidity environment, there has been a case where the strontium titanate particle contaminates a charging roller (a charging member for charging a photoreceptor).

On the other hand, a toner has been proposed which uses a resin having a crosslinked structure derived from at least one of boric acid and a boric acid derivative for the toner particle, and suppresses a decrease in transfer efficiency at the time of the durable use (Japanese Patent Application Laid-Open No. 2012-042539). In the proposal, the toner particle contains a boron-crosslinked resin, and thereby, the toner surface becomes hardened, which can suppress the deterioration of the toner particle (for example, such phenomena that an external additive is embedded in the toner particle surface, and that the toner particle is deformed), and can suppress a decrease in transfer efficiency; but there is room for improvement in the electrostatic chargeability.

As a result of studies by the present inventors, it has been confirmed that the toner described in Japanese Patent Application Laid-Open No. 2019-045578 has a certain effect of improving the charge rising property, due to the externally added strontium titanate particle acting as a microcarrier. However, there is a problem in long-term durability, and in particular, when the toner is subjected to the durable use in the low-temperature and low-humidity environment, the charging roller results in being contaminated with the strontium titanate particle, and when a halftone image has been output, there has been a case where a streaky image defect occurs thereon.

In addition, it has been found that the toner described in Japanese Patent Application Laid-Open No. 2012-042539 does not contain a strontium titanate particle, and accordingly, the charge rising property is insufficient; that, for example, in the case where a solid image is output under the low-temperature and low-humidity environment which is severe for the charge rising property, the density at the trailing edge of the image results in becoming thin; and that there is a problem from the viewpoint of the density uniformity.

Thus, any of the above conventional technology has problems in performance under a low-temperature and low-humidity environment, and the present invention is to provide a toner which solves the above problems. Specifically, the present invention provides a toner that is satisfactory in the charge rising property of the toner and contamination resistance of the charging roller; and even when having been subjected to the long-term durable use in a low-temperature and low-humidity environment, can output an image having high density uniformity of a solid image, and also having high uniformity of a halftone image.

### SUMMARY OF THE INVENTION

In order to solve the above problems, the present inventors have conducted intensive studies on the charge rising property of the toner, and on the contamination resistance of the charging roller. As a result, the present inventors have found that when the toner particle comprises a compound derived from a boron-oxygen bond in the vicinity of the surface, and comprises a strontium titanate particle which is surface-treated with a fatty acid, the toner can achieve both of the charge rising property (density uniformity of a solid image) and the contamination resistance of the charging member (uniformity of a halftone image), even in the case where the toner has been subjected to the durable use in the low-temperature and low-humidity environment.

In other words, the present invention is a toner comprising a toner particle comprising a binder resin and a strontium titanate particle, wherein in TOF-SIMS measurement of the toner particle, a fragment peak derived from a boron atom and a fragment peak derived from a boron-oxygen structure are detected, and a fatty acid exists on a surface of the strontium titanate particle.

Further features of the present invention will become apparent from the following description of exemplary embodiments.

### DESCRIPTION OF THE EMBODIMENTS

### [Features of the Invention]

As described above, as a technique for improving charge rising property of a toner, it is effective to externally add a strontium titanate particle to the toner particle. However, when the toner is subjected to the long-term durable use in the low-temperature and low-humidity environment, there has been a problem that the strontium titanate particle contaminates a charging member such as a charging roller.

The present inventors have conducted detailed studies on a reason why the strontium titanate particle tends to easily contaminate the charging member; and as a result, it has been found that the strontium titanate particle results in becoming an excessively charged particle, and its electrostatic adhesion force to the photoreceptor results in becoming too high; and that the strontium titanate particle cannot be cleaned in a cleaning step, and results in contaminating the charging member.

It has also been found that the phenomenon occurs because particularly in the low-temperature and low-humidity environment, the amount of water content in the air is small, accordingly, the electrostatic charge generated in the strontium titanate particle by “charging by exfoliation from the toner particle” tends to be easily retained; and that accordingly, when the toner is subjected to the long-term durable use, the toner is stirred in a developing unit or is rubbed with a developing blade, a developing roller, a photoreceptor or the like, and thereby, the electric charge is excessively accumulated in the toner particle and the strontium titanate particle.

Then, the present inventors have studied a surface treatment agent for the strontium titanate particle so that the strontium titanate particle is not excessively electrostatically charged, even in the case where the strontium titanate particle has been used for a long period of time in the low-temperature and low-humidity environment; however, the excessive electrostatic charging tends to have a trade-off relationship with the charge rising property of the toner, and thus the charge rising property (density uniformity of the solid image) and the contamination resistance of the charging member (uniformity of the halftone image) have not been able to be achieved at the same time only by the study.

Then, the present inventors have intensively studied on a surface design of the toner particle; as a result, have found that when the toner particle contains a compound derived from the boron-oxygen bond (BO bond) in the vicinity of the surface, and contains the strontium titanate particle which has been surface-treated with a fatty acid, the toner particle can achieve both of the charge rising property (density uniformity of the solid image) and the contamination resistance of the charging member (uniformity of the halftone image), even in the case of durable use in the low-temperature and low-humidity environment; and have completed the present invention.

The reason is not necessarily clear why the toner of the present invention can achieve both of the charge rising property (density uniformity of the solid image) and the contamination resistance of the charging member (uniformity of the halftone image) in the low-temperature and low-humidity environment, but the present inventors presume in the following way.

The toner particle of the present invention has the compound derived from the BO bond in the vicinity of the surface, and the compound derived from the BO bond has a bias of electric charges due to a difference in polarity (electronegativity) between a B atom and an O atom. In other words, the electric charges are biased so that the O atom is negative and the B atom is positive; and it is considered that the compound derived from the BO bond has a hydrogen bonding property with a water molecule having similarly high polarity, and it is considered that the compound derived from the BO bond tends to adsorb the water molecule in the vicinity of the surface of the toner particle.

On the other hand, it has been found from the investigation of the present inventors that when a fatty acid exists on the surface of strontium titanate, the strontium titanate particle exhibits an ability of slightly retaining a water molecule in the vicinity of the surface, and a positive charge generated by exfoliation charging can be gradually released into the air by the water molecule. This is considered to be because a carboxyl terminal of the fatty acid also has a hydrogen bonding property with a water molecule.

Thus, it is presumed that even when the toner of the present invention is subjected to the long-term durable use in the low-temperature and low-humidity environment, the water molecule carried in the vicinity of the surface of the toner particle migrates to the fatty acid existing on the surface of the strontium titanate particle, and the fatty acid constantly carries an appropriate amount of water molecules; and accordingly, that the toner does not become excessively charged particle.

Note that in a case where the toner particle does not have a compound derived from the BO bond in the vicinity of the surface, it is difficult for the fatty acid existing on the surface of the strontium titanate particle to continue carrying a water molecule constantly, and an effect of gradually releasing the positive charge is insufficient; and accordingly, that in the case where the toner particle is used for a long period of time in the low-temperature and low-humidity environment, the contamination resistance of the charging member cannot be improved.

Next, the main constituent components of the present invention will be described.

<Having Compound Derived from BO Bond in Vicinity of Surface of Toner Particle>

It is necessary that the toner of the present invention includes a toner particle containing a binder resin, and that in TOF-SIMS measurement of the toner particle, a fragment peak derived from a boron atom and a fragment peak derived from a boron-oxygen structure (BO structure) are detected.

The composition and structure of the compound existing in the vicinity of the surface of the toner particle can be identified by TOF-SIMS measurement of the toner particle. In addition, the fact that the fragment peak derived from the boron atom and the fragment peak derived from the BO structure are detected by the TOF-SIMS measurement indicates that a compound derived from the BO bond exists in the vicinity of the surface of the toner particle.

Due to the compound derived from the BO bond existing in the vicinity of the surface of the toner particle, it becomes easy for a water molecule to be carried in the vicinity of the surface of the toner particle. Because of this, as described above, when the strontium titanate particle is charged by exfoliation, water molecules are constantly supplied from the vicinity of the surface of the toner particle to the fatty acid of the strontium titanate particle, which can prevent the strontium titanate particle from causing excessive electrostatic charging even in the low-temperature and low-humidity environment, and the contamination resistance of the charging member becomes satisfactory.

The TOF-SIMS can qualitatively measure a region of ₁₀ nm or shallower from the surface of the toner. As for the presence or absence of the BO bond, sodium tetraborate decahydrate (produced by Fuji Film Wako Pure Chemical Corporation) is subjected to TOF-SIMS as a standard sample, in advance. Concerning the measured data, peak positions derived from the boron atom and BO₂ (typical structure having BO bond) are confirmed, in advance. After that, the target toner is subjected to the TOF-SIMS measurement, and thereby, the presence or absence of the boron atom and the BO bond can be known.

The method for measuring the fragment peaks derived from the boron atom and the BO structure will be described later.

When there are the peaks of the boron atom and the BO bond, the above described action effect are exhibited, and also in the case where the toner has been subjected to the durable use under the low-temperature and low-humidity environment, the strontium titanate particle can be prevented from causing the excessive electrostatic charging, and the contamination resistance of the charging member becomes satisfactory.

The technique for incorporating the BO bond into the surface layer of the toner particle is not particularly limited, but for example, boric acid can be incorporated into the toner particle, by internal addition of boric acid to the toner particle, or usage of boric acid as an aggregating agent in an aggregation method. Due to the addition of the boric acid as the aggregating agent, the boric acid tends to become easily introduced into the vicinity of the surface of the toner particle. At a stage of using as a raw material, the raw material may be used in a form of organic boric acid, a borate, a borate ester or the like. When the toner particle is produced in an aqueous medium, it is preferable to add the boric acid as a borate from the viewpoint of reactivity and production stability; and specific examples thereof include sodium tetraborate and ammonium borate, and in particular, borax is preferably used.

Borax is expressed by decahydrate of sodium tetraborate (Na₂B₄O₇), and changes into boric acid in an acidic aqueous solution; and accordingly, when a boric acid source is used in an acidic environment in an aqueous medium, borax is preferably used.

<Having Strontium Titanate Particle in which Fatty Acid Exists on Surface>

It is necessary for the toner of the present invention to have a compound derived from the BO bond in the vicinity of the surface of the toner particle, and in addition, have a strontium titanate particle having a fatty acid on the surface.

Due to the strontium titanate particle being contained, even in the case where the toner is subjected to the long-term durable use in the low-temperature and low-humidity environment which is an environment severe for the charge rising property of the toner, a satisfactory charge rising property is exhibited, and the density uniformity of a solid image becomes satisfactory. In addition, due to the above described action effect, the contamination resistance of the charging member also becomes satisfactory.

It has been found from the investigation of the present inventors that the water molecule having a high polarity has an effect of increasing a speed of transferring an electric charge between objects, in triboelectric charging, and accordingly that in a conventional toner, there is a case where the charge rising speed becomes insufficient, and in particular, the density uniformity of the solid image is worsened, in the low-temperature and low-humidity environment in which the absolute water content in the air is low. Specifically, it is such a phenomenon that the image density becomes thin at the image trailing edge portion of the solid image.

It is presumed that in the toner of the present invention, due to the action of the compound derived from the BO bond existing in the vicinity of the surface of the toner particle and the fatty acid existing on the surface of the strontium titanate particle, an appropriate amount of water molecule results in existing at the interface between particles, and the charge rising property under the low-temperature and low-humidity environment becomes satisfactory.

### <Abundance X of Boron Atom>

In the toner of the present invention, it is preferable that an abundance (based on mass) X of a boron atom in the toner measured by an inductively coupled plasma mass spectrometry apparatus (ICP-MS) is from 0.1 to 100 ppm from the viewpoint that the toner can acquire a more satisfactory electrostatic chargeability and improve suppression of fogging in the low-temperature and low-humidity environment and a high-temperature and high-humidity environment. A specific measurement method by the analysis apparatus will be described later.

Due to the abundance X of the boron atoms being 0.1 ppm or more, the toner particle can carry an appropriate amount of a water content in the vicinity of its surface, and can suppress a charge-up of the toner. Accordingly, even when a low-print image is continuously output for a long period of time in the low-temperature and low-humidity environment, the toner can suppress the fogging onto a white background portion, which is preferable. It is more preferable for the abundance X of the boron atom to be 0.2 ppm or more, and is particularly preferable to be 0.3 ppm or more.

On the other hand, due to the abundance X of the boron atoms being 100 ppm or less, the amount of the water content carried in the vicinity of the surface of the toner particle does not become excessively large, and accordingly, the charge amount of the toner tends to be easily maintained also under the high-temperature and high-humidity environment. Because of this, even in the case where the low-print image is output for a long period of time under the high-temperature and high-humidity environment, the toner can suppress the fogging onto a non-image portion, which is preferable. It is more preferable for the abundance X of the boron atoms to be 70.0 ppm or less, is further preferable to be 5.0 ppm or less, and is particularly preferable to be 2.0 ppm or less.

### <Content Y of Strontium Titanate Particle>

In the toner of the present invention, it is preferable that a content Y (% by mass) of the strontium titanate particles is from 0.1 to 4.0, from the viewpoint that the toner achieves both the charge rising property and the contamination resistance to the charging member.

Specifically, due to the content Y of the strontium titanate particles being 0.1% by mass or more, the solid density uniformity becomes further satisfactory even when the toner is subjected to the long-term durable use in the low-temperature and low-humidity environment, which is preferable. On the other hand, due to the content Y of the strontium titanate particles being 4.0% by mass or less, the amount of the strontium titanate particles transferred to the photoreceptor becomes an appropriate amount, and the strontium titanate particles are not excessively supplied to a cleaning portion; and accordingly, the contamination resistance of the charging member becomes further satisfactory, which is preferable.

### <Fatty Acid>

It is necessary for the strontium titanate particle of the present invention that a fatty acid exists on the surface thereof.

Due to the fatty acid existing on the surface, as described above, an appropriate amount of a water content is constantly supplied from the vicinity of the surface of the toner particle to the fatty acid on the surface of the strontium titanate particle, at the time of causing exfoliation charging, and the contamination resistance of the charging member becomes satisfactory while the strontium titanate particle does not cause excessive electrostatic charging.

The fatty acids of the present invention are not particularly limited as long as the fatty acids have a structure in which hydrocarbon group (R—) and a carboxyl group (—COOH) are bonded; and specific examples thereof include caprylic acid, lauric acid, myristic acid, palmitic acid, stearic acid, lignoceric acid and melissic acid.

In addition, it is preferable that the fatty acid is a fatty acid in which an alkyl group having from 12 to 30 carbon atoms and a carboxyl group are bonded, from the viewpoint of control of the hydrophilicity and hydrophobicity of the fatty acid.

With the number of carbon atoms being 12 or more, the hydrophobicity of the fatty acid becomes sufficiently high. Because of this, also in the case where a high-print image in which a large number of the toners are consumed is continuously output under the high-temperature and high-humidity environment in which the absolute amount of the water content is large, the charge amount of the toner can be stabilized, and the fogging in a non-image portion can be more satisfactorily suppressed, which is preferable.

Meanwhile, with the number of carbon atoms being 30 or less, the hydrophilicity of the fatty acid becomes sufficiently high.

Because of this, even in the case where the image with a high printing rate, which consumes a large number of the toners, is continuously output in the low-temperature and low-humidity environment in which an absolute water content is small, the charge rising property of the toner becomes satisfactory, and the fogging in the non-image portion can be more satisfactorily suppressed, which are preferable.

### <Combined Use of Fatty Acid>

From the viewpoint that the charge amount distribution of the obtained toner becomes sharper and the line width stability becomes more satisfactory, it is preferable that two fatty acids having different numbers of carbon atoms exist on the surface of the strontium titanate particle, the numbers of carbon atoms of the two fatty acids are both from 12 to 30, and the difference in the number of carbon atoms between the two fatty acids is 2 or more. Examples include a combined use of stearic acid having 18 carbon atoms and palmitic acid having 16 carbon atoms, and a combined use of lignoceric acid having 24 carbon atoms and lauric acid having 12 carbon atoms.

The reason why such an action effect is obtained is not clear, but it is presumed that because two fatty acids having different numbers of carbon atoms exist on the surface of the strontium titanate particle, an electric charge moves in the surface of the strontium titanate particle due to the difference in hydrophilicity and hydrophobicity between the fatty acids, and thus the electric charge tends to become easily uniformized.

In addition, it is anticipated that when the toner particle and the strontium titanate particle are peeled from each other, the charge amount between the particles on the toner particle side also tends to be easily stabilized, and the charge amount distribution becomes sharp.

It is considered that due to the charge amount distribution being sharp, the development efficiency and the transfer efficiency of the vertical line and the horizontal line become uniform, and accordingly, the line width stability of the vertical line and the horizontal line becomes satisfactory.

### <Content Z of Fatty Acid>

A content Z (% by mass) of the fatty acid having from 12 to 30 carbon atoms existing on the surface of the strontium titanate particle is preferably from 0.10 to 5.0 from the viewpoint that the contamination resistance of the charging member becomes further satisfactory and the solid image density uniformity under the high-temperature and high-humidity environment becomes further satisfactory.

Due to the content Z of the fatty acid being 0.10% by mass or more, the strontium titanate particle tends to easily receive and give the water content from the vicinity of the surface of the toner particle, and the contamination resistance of the charging member becomes satisfactory while the toner particle is not excessively charged. Because of this, even when the image having a high printing rate is output in a continuous output mode, which is a mode in which the amount of the toner to be consumed is large and the strontium titanate particles are easily supplied to a cleaning portion and the contamination resistance of the charging member is severe, the density uniformity of a halftone image becomes satisfactory, which is preferable; and the content is more preferably 0.30% by mass or more.

On the other hand, due to the content Z of the fatty acid being 5.0% by mass or less, even in the high-temperature and high-humidity environment in which the fluidity of the toner tends to be worsened by the influence of the water content, the fluidity of the toner containing the strontium titanate becomes satisfactory, which is preferable. Because of this, even in a severe mode in which a large number of toners are consumed and an image having a high printing rate is continuously output, the charge rising property of the toner becomes satisfactory, and accordingly, the uniformity of the density between images becomes satisfactory, which is preferable.

A method of quantitatively determining the fatty acid existing on the surface of the strontium titanate particle will be described later.

### <Relationship Between X and Y>

In the toner of the present invention, from the viewpoint that the contamination resistance of the charging member becomes further satisfactory, it is preferable that the abundance (based on mass) X (ppm) of boron atoms in the toner and the content Y (% by mass) of the strontium titanate particles in the toner satisfy the following Expression:

0.10≤X/Y≤30.0.

The X/Y is a ratio of the abundance of the boron atoms existing in the vicinity of the surface of the toner particle to the content of the strontium titanate particles in the toner, and due to the X/Y value being controlled in a preferable range, the water content carried in the vicinity of the surface of the toner particle can be stably supplied to the surface of the strontium titanate particle, and the contamination resistance of the charging member can become further satisfactory, which is preferable.

In the case where the X/Y is 0.10 or larger, the abundance X of the boron atoms in the vicinity of the surface of the toner particle is sufficient, with respect to the content Y of the strontium titanate particles in the toner. Because of this, a sufficient amount of the water content can be supplied to the strontium titanate particle, and the excessive electrostatic charging of the strontium titanate particle can be suppressed; and accordingly, the contamination resistance of the charging member in the low-temperature and low-humidity environment becomes further satisfactory. It is more preferable that the X/Y is 0.30 or larger.

On the other hand, due to the X/Y being 30.0 or smaller, the abundance X of the boron atoms existing in the vicinity of the surface of the toner particle is maintained at an appropriate amount with respect to the content Y of the strontium titanate particles in the toner, and is in a state of not being excessively large. Because of this, the compound having the BO structure in the vicinity of the surface of the toner particle does not excessively have affinity for the water content, and can stably supply the water content to the surface of the strontium titanate particle.

Therefore, the toner particle can suppress excessive electrostatic charging of the strontium titanate particle, and the contamination resistance of the charging member in the low-temperature and low-humidity environment becomes further satisfactory, which is preferable. It is further preferable that the X/Y is 25.0 or smaller.

### <Relationship Between X and Z>

In the toner of the present invention, from the viewpoint that the charge rising property becomes further satisfactory, it is preferable that the abundance (based on mass) X (ppm) of boron atoms in the toner and the content Z (% by mass) of the fatty acid having from 12 to 30 carbon atoms existing on the surfaces of the strontium titanate particles satisfy the following Expression:

0.020≤X/Z≤15.0.

The X/Z is a ratio of the abundance of the boron atoms existing in the vicinity of the surface of the toner particle to the content of the fatty acid having from 12 to 30 carbon atoms existing on the surfaces of the strontium titanate particles in the toner, and due to the X/Z value being controlled in a preferable range, the water content carried in the vicinity of the surface of the toner particle dose not excessively migrate to the surface of the strontium titanate particle, and the toner particle is controlled to an appropriate state. Thereby, the charge rising property of the toner particle can become further satisfactory, which is preferable.

The case where the X/Z is 0.020 or larger shows that the abundance X of the boron atoms existing in the vicinity of the surface of the toner particle is sufficient, with respect to the content Z of the fatty acid having from 12 to 30 carbon atoms existing on the surfaces of the strontium titanate particles in the toner. Because of this, even when the water content migrates to the strontium titanate particle, a sufficient amount of the water content exists in the vicinity of the surface of the toner particle; and accordingly, even when the toner has been left to stand for a long period of time in the low-temperature and low-humidity environment, the charge rising property becomes satisfactory, and the density uniformity of the solid image becomes satisfactory, which is preferable. It is more preferable that the X/Z is 0.030 or larger.

On the other hand, in the case where X/Z is 15.0 or smaller, the abundance X of the boron atoms in the vicinity of the surface of the toner particle is in a state of being maintained at an appropriate amount and being not excessively large, with respect to the content Z of the fatty acid having from 12 to 30 carbon atoms existing on the surfaces of the strontium titanate particles in the toner. Because of this, in the vicinity of the surface of the toner particle, the compound having the BO structure does not result in excessively storing the water content, and even in the case where the toner has been left to stand for a long period of time under the high-temperature and high-humidity environment which is a severer mode, the charge amount of the toner becomes satisfactory. Therefore, the density uniformity of the image becomes satisfactory, which is preferable. It is more preferable that the X/Z is 12.5 or smaller.

### <Average Circularity of Toners>

In the toner of the present invention, it is preferable that an average circularity is from 0.960 to 0.990, from the viewpoint that the line width stability of a halftone image becomes further satisfactory.

Due to the average circularity of the toner being 0.960 or larger, a rolling property of the toner becomes satisfactory, and accordingly the charge rising property becomes further satisfactory. Because of this, the charge amount distribution under the low-temperature and low-humidity environment becomes sharp, and the stability of the line width of the vertical line and the horizontal line becomes satisfactory, which is preferable.

On the other hand, due to the average circularity of the toner being 0.990 or smaller, the rolling property of the toner is not excessively high, and the non-electrostatic adhesion force can be appropriately enhanced; and accordingly, the toners can suppress scattering of themselves in the transfer step, and the line width stability also becomes satisfactory, which is preferable.

It is more preferable for the average circularity of the toner to be from 0.965 to 0.985, and is particularly preferable to be from 0.967 to 0.983.

In order to adjust the circularity of the toner to a preferable range in the present invention, it is preferable to adopt a method for producing a chemical toner, such as an emulsion aggregation method, a suspension polymerization method or a suspension granulation method, as a method for producing the toner.

When the emulsion aggregation method is used, it is preferable to adjust the circularity by providing a spheroidizing step, in order to obtain a desired surface shape of the toner. In addition, when the pulverization method is used, the circularity of the toner can also be adjusted by performing surface treatment with hot air by a thermal spheroidizing treatment.

### <Titanium Oxide Particle>

It is also preferable that the toner of the present invention contains a titanium oxide particle which satisfies the following (i) and (ii), in addition to the above strontium titanate particle.
(i) A major axis is from 300 to 3000 nm, and
(ii) an aspect ratio is 5.0 or larger.

A titanium oxide particle satisfying the above (i) and (ii) is classified to have a large particle size and low resistance as an external additive, and shows that the structure has a needle shape. A use of the titanium oxide particle can suppress an excessive electrostatic charging in the low-temperature and low-humidity environment, and exhibits a spacer effect on the surface of the toner particle: and accordingly, the change in fluidity at the time of the long-term use becomes small. In the present invention, there is a synergistic action among an effect due to the existence of the structure derived from the BO bond in the vicinity of the surface of the toner particle, an action capable of carrying a water molecule on the surface of the toner particle, and an effect due to inclusion of the titanium oxide particle having the particular shape, and the synergistic action can more satisfactorily suppress the fogging after the low-printing continuous durability evaluation under the low-temperature and low-humidity environment, which is preferable.

The content of the above titanium oxide particles in the toner is preferably from 0.1 to 10.0% by mass. The lower limit is more preferably 0.2% by mass or more. In addition, the upper limit is more preferably 1.0% by mass or less.

Note that the above titanium oxide particle is not particularly limited as long as the titanium oxide particle satisfies the above requirements (i) and (ii). For example, a rutile-type titanium oxide particle is one of preferable forms. In addition, from the viewpoint of imparting the fluidity to the toner, a titanium oxide particle which does not correspond to the above titanium oxide particle can be used in combination.

### <Shell Layer on Surface of Toner Particle>

The toner of the present invention has a shell layer on the surface of the toner particle; and it is preferable that the shell layer contains a polyester resin, the shell layer does not contain a crystalline material in a cross section of the toner, which is observed with a transmission electron microscope, and when T (nm) represents a thickness of the shell layer, the shell layer satisfies the following Expression;

300≤T≤700.

The toner particle of which the shell layer is formed from a polyester resin has polarity also in a region of the surface of the toner particle other than the BO structure, accordingly water molecules tend to be easily carried by the BO structure, and an effect of suppressing the excessive electrostatic charging of the above strontium titanate particle tends to be easily obtained, which is preferable.

In addition, due to the shell layer which does not contain the crystalline material and satisfies the above Expression, embedding of the external additive in the surface of the toner is suppressed even when the toner is used in the low-temperature and low-humidity environment for a long period of time; and the effect of the strontium titanate particle as a microcarrier is stably exhibited, and charging stability is enhanced, which is preferable. Thereby, fogging under the low-temperature and low-humidity environment is improved, which is preferable, and in particular, fogging in the high-printing durability printing is improved, which is preferable.

Note that a step of forming the shell layer on the surface of the toner particle will be described in detail later.

### [Other Configurations of the Present Invention]

### <Binder Resin>

The toner particle of the present invention contains a binder resin. It is preferable that a content of the binder resin is 50% by mass or more of the total amount of the resin components in the toner particle.

The binder resins are not particularly limited, and examples thereof include a styrene acrylic resin, an epoxy resin, a polyester resin, a polyurethane resin, a polyamide resin, a cellulose resin, a polyether resin, and mixed resins and composite resins of these resins. The styrene acrylic resin and the polyester resin (details of the polyester resin are described below) are preferable from the viewpoint of low-temperature fixability and durability stability.

Examples of the styrene acrylic resin include: homopolymers formed from the following polymerizable monomers; copolymers obtained by combining two or more types of these polymerizable monomers; and further mixtures thereof.

Styrene-based monomers such as styrene, α-methylstyrene, β-methylstyrene, o-methylstyrene, m-methylstyrene, p-methylstyrene, 2,4-dimethylstyrene, p-n-butylstyrene, p-tert-butylstyrene, p-n-hexylstyrene, p-n-octylstyrene, p-n-nonylstyrene, p-n-decylstyrene, p-n-dodecylstyrene, p-methoxystyrene and p-phenylstyrene;
(meth)acrylic monomers such as methyl (meth)acrylate, ethyl (meth)acrylate, n-propyl (meth)acrylate, iso-propyl (meth)acrylate, n-butyl (meth)acrylate, iso-butyl (meth)acrylate, tert-butyl (meth)acrylate, n-amyl (meth)acrylate, n-hexyl (meth)acrylate, 2-ethylhexyl (meth)acrylate, n-octyl (meth)acrylate, n-nonyl (meth)acrylate, cyclohexyl (meth)acrylate, benzyl (meth)acrylate, dimethyl phosphate ethyl (meth) acrylate, diethyl phosphate ethyl (meth) acrylate, dibutyl phosphate ethyl (meth) acrylate, 2-benzoyloxyethyl (meth)acrylate, (meth)acrylonitrile, 2-hydroxyethyl (meth)acrylate, (meth)acrylic acid, and maleic acid;
vinyl ether-based monomers such as vinyl methyl ether and vinyl isobutyl ether; vinyl ketone-based monomers such as vinyl methyl ketone, vinyl ethyl ketone, and vinyl isopropenyl ketone; and
polyolefins such as ethylene, propylene and butadiene.

The styrene acrylic resin can contain a polyfunctional polymerizable monomer as needed. Examples of the polyfunctional polymerizable monomer include: diethylene glycol di(meth)acrylate, triethylene glycol di(meth)acrylate, tetraethylene glycol di(meth)acrylate, polyethylene glycol di(meth)acrylate, 1,6-hexanediol di(meth)acrylate, neopentyl glycol di(meth)acrylate, tripropylene glycol di(meth)acrylate, polypropylene glycol di(meth)acrylate, 2,2′-bis(4-((meth)acryloxydiethoxy)phenyl) propane, trimethylolpropane tri(meth)acrylate, tetramethylolmethane tetra(meth)acrylate, divinylbenzene, divinylnaphthalene and divinyl ether.

In addition, in order to control a degree of polymerization, a known chain transfer agent and a known polymerization inhibitor can also be further added. Examples of the polymerization initiator for obtaining the styrene acrylic resin include organic peroxide-based initiators and azo-based polymerization initiators.

Examples of the organic peroxide-based initiator include: benzoyl peroxide, lauroyl peroxide, di-α-cumyl peroxide, 2,5-dimethyl-2,5-bis(benzoylperoxy) hexane, bis(4-t-butylcyclohexyl) peroxydicarbonate, 1,1-bis(t-butylperoxy) cyclododecane, t-butyl peroxymaleic acid, bis(t-butylperoxy) isophthalate, methyl ethyl ketone peroxide, tert-butyl peroxy-2-ethylhexanoate, diisopropyl peroxycarbonate, cumene hydroperoxide, 2,4-dichlorobenzoyl peroxide and tert-butyl-peroxypivalate.

Examples of the azo-based polymerization initiator include: 2,2′-azobis-(2,4-dimethylvaleronitrile), 2,2′-azobisisobutyronitrile, 1,1′-azobis(cyclohexane-1-carbonitrile), 2,2′-azobis-4-methoxy-2,4-dimethylvaleronitrile, azobismethylbutyronitrile, and 2,2′-azobis-(methyl isobutyrate).

In addition, as the polymerization initiator, a redox-based initiator can also be used in which an oxidizing substance and a reducing substance are combined.

The oxidizing substance includes: hydrogen peroxide; an inorganic peroxide of a persulfate (a sodium salt, a potassium salt and an ammonium salt); and an oxidizing metal salt of a tetravalent cerium salt.

Examples of the reducing substance include; a reducing metal salt (a divalent iron salt, a monovalent copper salt and a trivalent chromium salt); ammonia; a lower amine (an amine having from about 1 to 6 carbon atoms, such as methylamine and ethylamine); an amino compound such as hydroxylamine; a reducing sulfur compound such as sodium thiosulfate, sodium hydrosulfite, sodium hydrogen sulfite, sodium sulfite and sodium formaldehyde sulfoxylate; a lower alcohol (having from 1 to 6 carbon atoms); ascorbic acid or a salt thereof; and a lower aldehyde (having from 1 to 6 carbon atoms).

The polymerization initiators are selected with reference to a 10-hour half-life temperature, and are used singly or in mixture. The amount of the polymerization initiator to be added varies depending on a desired degree of polymerization, but is generally from 0.5 to 20.0 parts by mass with respect to 100.0 parts by mass of the polymerizable monomer.

In the toner of the present invention, a constitution is preferable in which the binder resin is a styrene acrylic resin and the shell layer includes a polyester resin, because the chargeability under a low temperature and a high temperature and a high humidity environment is well balanced.

### <Polyester Resin>

A polyester resin to be used in the toner particle of the present invention will be described below. The polyester resin described below can be used also for the polyester resin contained in the shell layer existing on the surface of the toner particle of the present invention. The polyester resin that can be used in the present invention is not particularly limited, but is preferably an amorphous polyester resin; and examples thereof include the following.

The polyester resin is obtained by selection and combination of suitable ones from polyvalent carboxylic acid, polyol, hydroxycarboxylic acid and the like, and synthesis by a known method such as an ester exchange method or a polycondensation method. Preferably, the polyester resin includes a polycondensate of a dicarboxylic acid and a diol.

The polyvalent carboxylic acid is a compound containing two or more carboxy groups in one molecule. Among these compounds, dicarboxylic acid is a compound containing two carboxy groups in one molecule and is preferably used.

The examples include: oxalic acid, succinic acid, glutaric acid, maleic acid, adipic acid, β-methyladipic acid, azelaic acid, sebacic acid, nonanedicarboxylic acid, decanedicarboxylic acid, undecanedicarboxylic acid, dodecanedicarboxylic acid, fumaric acid, citraconic acid, diglycolic acid, cyclohexane-3,5-diene-1,2-carboxylic acid, hexahydroterephthalic acid, malonic acid, pimelic acid, suberic acid, phthalic acid, isophthalic acid, terephthalic acid, tetrachlorophthalic acid, chlorophthalic acid, nitrophthalic acid, p-carboxyphenylacetic acid, p-phenylenediacetic acid, m-phenylenediacetic acid, o-phenylenediacetic acid, diphenylacetic acid, diphenyl-p,p′-dicarboxylic acid, naphthalene-1,4-dicarboxylic acid, naphthalene-1,5-dicarboxylic acid, naphthalene-2,6-dicarboxylic acid, anthracenedicarboxylic acid and cyclohexanedicarboxylic acid.

In addition, examples of the polyvalent carboxylic acid other than the above dicarboxylic acid include: trimellitic acid, trimesic acid, pyromellitic acid, naphthalene tricarboxylic acid, naphthalene tetracarboxylic acid, pyrene tricarboxylic acid, pyrene tetracarboxylic acid, itaconic acid, glutaconic acid, n-dodecyl succinic acid, n-dodecenyl succinic acid, isododecyl succinic acid, isododecenyl succinic acid, n-octyl succinic acid and n-octenyl succinic acid. These may be used singly, or in combinations of two or more thereof.

The polyol is a compound having two or more hydroxyl groups in one molecule. Among these polyols, a diol is a compound containing two hydroxyl groups in one molecule, and is preferably used.

Specific examples include: ethylene glycol, diethylene glycol, triethylene glycol, 1,2-propanediol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, 1,14-eicosandecanediol, dipropylene glycol, polyethylene glycol, polypropylene glycol, polytetramethylene ether glycol, 1,4-cyclohexanediol, 1,4-cyclohexanedimethanol, 1,4-butenediol, neopentyl glycol, polytetramethylene glycol, hydrogenated bisphenol A, bisphenol A, bisphenol F, bisphenol S, and alkylene oxide (ethylene oxide, propylene oxide, butylene oxide and the like) adducts of the above bisphenols.

Among the compounds, alkylene glycols having from 2 to 12 carbon atoms and alkylene oxide adducts of bisphenols are preferable; and alkylene oxide adducts of bisphenols, and combination use of the adducts with alkyleneglycols having from 2 to 12 carbon atoms are particularly preferable. The alkylene oxide adduct of bisphenol A includes a compound represented by the following Formula (A).

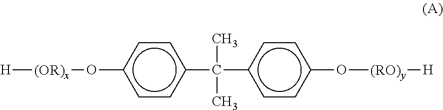

(wherein R is each independently an ethylene group or a propylene group, x and y are each an integer of 0 or more, and an average value of x+y is from 0 to 10.)

It is preferable that the alkylene oxide adduct of bisphenol A is a propylene oxide adduct and/or an ethylene oxide adduct of bisphenol A. More preferably, the alkylene oxide adduct is the propylene oxide adduct. In addition, it is preferable that an average value of x+y is from 1 to 5 or smaller.

Examples of a trivalent or higher alcohol include: glycerin, trimethylolethane, trimethylolpropane, pentaerythritol, hexamethylolmelamine, hexaethylolmelamine, tetramethylolbenzoguanamine, tetraethylolbenzoguanamine, sorbitol, trisphenol PA, phenol novolac, cresol novolac, and alkylene oxide adducts of the above trivalent or higher polyphenols. These may be used singly, or in combinations of two or more thereof.

Regarding physical properties of the polyester resin to be used in the present invention, a weight-average molecular weight is preferably from 9000 to 15000 and an acid number is preferably from 4.0 to 10.0 mgKOH/g.

### <Release Agent>

In the toner, a known wax can be used as a release agent.

Specific examples thereof include: petroleum-based waxes represented by paraffin wax, microcrystalline wax and petrolatum, and derivatives thereof; montan wax and derivatives thereof; hydrocarbon wax produced by a Fischer-Tropsch method and derivatives thereof; polyolefin waxes represented by polyethylene, and derivatives thereof; natural waxes represented by carnauba wax and candelilla wax, and derivatives thereof. The derivatives include oxides, block copolymers with a vinyl monomer, and graft modified products.

The specific examples also include: alcohols such as higher aliphatic alcohols; fatty acids such as stearic acid and palmitic acid, or acid amides, esters and ketones thereof; hydrogenated castor oil and derivatives thereof; vegetable waxes; and animal waxes. These can be used singly or in combinations.

Among these waxes and the like, in a case where polyolefin, hydrocarbon wax produced by a Fischer-Tropsch method or petroleum-based wax is used, the developability and transferability tend to be improved, which is preferable. Note that an antioxidant may be added to these waxes in such a range as not to give influence on the effect of the toner. In addition, suitable examples, from the viewpoint of phase separation properties with respect to the binder resin or a crystallization temperature, include higher fatty acid esters such as behenyl behenate and dibehenyl sebacate.

In addition, it is preferable that a content of the release agent is from 1.0 to 30.0 parts by mass, with respect to 100.0 parts by mass of the binder resin.

A melting point of the release agent is preferably from 30 to 120° C., and is more preferably from 60 to 100° C. Due to use of such a release agent as to exhibit the thermal characteristics as described above, the release effect is efficiently exhibited, and a wider fixing region is secured.

### <Plasticizer>

The toner particle may contain a crystalline plasticizer in order to improve a sharp meltability. The plasticizer is not particularly limited, and the following known plasticizers can be used which are used for toners.

Specific examples include: esters of a monovalent alcohol and an aliphatic carboxylic acid, such as behenyl behenate, stearyl stearate and palmityl palmitate, or esters of a monovalent carboxylic acid and an aliphatic alcohol; esters of a divalent alcohol and an aliphatic carboxylic acid, such as ethylene glycol distearate, dibehenyl sebacate and hexanediol dibehenate, or esters of a divalent carboxylic acid and an aliphatic alcohol; esters of a trivalent alcohol and an aliphatic carboxylic acid, such as glycerol tribehenate, or esters of a trivalent carboxylic acid and an aliphatic alcohol; esters of a tetravalent alcohol and an aliphatic carboxylic acid, such as pentaerythritol tetrastearate and pentaerythritol tetrapalmitate, or esters of a tetravalent carboxylic acid and an aliphatic alcohol; esters of a hexavalent alcohol and an aliphatic carboxylic acid, such as dipentaerythritol hexastearate and dipentaerythritol hexapalmitate, or esters of a hexavalent carboxylic acid and an aliphatic alcohol; esters of a polyvalent alcohol and an aliphatic carboxylic acid, such as polyglycerol behenate, or esters of a polyvalent carboxylic acid and an aliphatic alcohol; and natural ester waxes such as carnauba wax and rice wax. These can be used singly or in combinations.

### <Coloring Agent>

The toner particle may contain a coloring agent. As the coloring agent, a known pigment or dye can be used. As the coloring agent, a pigment is preferable from the viewpoint of being excellent in weather resistance.

Examples of a cyan coloring agent include: copper phthalocyanine compounds and derivatives thereof; anthraquinone compounds; and basic dye lake compounds. Specific examples thereof include the following coloring agents: C. I. Pigment Blue 1, 7, 15, 15:1, 15:2, 15:3, 15:4, 60, 62 and 66.

Examples of a magenta coloring agent include condensed azo compounds, diketopyrrolopyrrole compounds, anthraquinone compounds, quinacridone compounds, basic dye lake compounds, naphthol compounds, benzimidazolone compounds, thioindigo compounds and perylene compounds. Specific examples thereof include the following coloring agents: C. I. Pigment Red 2, 3, 5, 6, 7, 23, 48:2, 48:3, 48:4, 57:1, 81:1, 122, 144, 146, 150, 166, 169, 177, 184, 185, 202, 206, 220, 221 and 254: and C. I. Pigment Violet 19.

Examples of a yellow coloring agent include: condensed azo compounds, isoindolinone compounds, anthraquinone compounds, azo metal complexes, methine compounds and allylamide compounds. Specific examples thereof include the following coloring agents: C. I. Pigment Yellow 12, 13, 14, 15, 17, 62, 74, 83, 93, 94, 95, 97, 109, 110, 111, 120, 127, 128, 129, 147, 151, 154, 155, 168, 174, 175, 176, 180, 181, 185, 191 and 194.

Examples of a black coloring agent include: a coloring agent which is toned to black with the above yellow coloring agent, the magenta coloring agent and the cyan coloring agent; carbon black; and magnetic substances.

These coloring agents can be used singly or as a mixture, and further can be used in a state of a solid solution. It is preferable to use the coloring agent in an amount of from 1.0 to 20.0 parts by mass, with respect to 100.0 parts by mass of the binder resin. In a case where a production method that uses a magnetic substance in an aqueous medium is applied to the toner particle, which will be described later, the magnetic substance can also be subjected to hydrophobic treatment for the purpose of causing the resin to stably contain the magnetic substance therein.

### <Charge Control Agent and Charge Control Resin>

The toner particle may contain a charge control agent or a charge control resin. As the charge control agent, known charge control agents can be used, and particularly, the charge control agent is preferable which has a high triboelectric charging speed and can stably maintain a constant triboelectric charge amount. Furthermore, when the toner particle is produced according to a suspension polymerization method, a charge control agent is particularly preferable which has low polymerization inhibiting property and does not substantially contain a substance soluble in the aqueous medium.

Examples of compounds that control the toner to negative chargeability include: monoazo metal compounds: acetylacetone metal compounds; metal compounds of aromatic oxycarboxylic acid, aromatic dicarboxylic acid, oxycarboxylic acid and dicarboxylic acid; aromatic oxycarboxylic acid, aromatic mono- and polycarboxylic acids, and metal salts, anhydrides and esters thereof; phenol derivatives such as bisphenol; urea derivatives; metal-containing salicylic acid-based compounds; metal-containing naphthoic acid-based compounds; boron compounds; quaternary ammonium salts; calixarenes; and charge control resins.

Examples of the charge control resin include polymers or copolymers having a sulfonic acid group, a sulfonate group or a sulfonic acid ester group. It is particularly preferable for the polymer having a sulfonic acid group, a sulfonate group or a sulfonic acid ester group to contain a sulfonic acid group-containing acrylamide-based monomer or a sulfonic acid group-containing methacrylamide-based monomer in an amount of 2% by mass or more by a copolymerization ratio, and is more preferable to contain any of the monomers in an amount of 5% by mass or more.

It is preferable for the charge control resin that a glass transition temperature (Tg) is from 35 to 90° C., a peak molecular weight (Mp) is from 10000 to 30000, and a weight-average molecular weight (Mw) is from 25000 to 50000. When this charge control resin is used, the charge control resin can impart favorable triboelectric charging characteristics to the toner particle without affecting the required thermal characteristics. Furthermore, when the charge control resin contains the sulfonic acid group, for example, the dispersibility of the charge control resin itself in the polymerizable monomer composition and the dispersibility of the coloring agent and the like are improved, and the coloring power, transparency and triboelectric charging characteristics can be further improved.

These charge control agents or charge control resins may be added singly or in combinations of two or more thereof. The amount of the charge control agent or the charge control resin to be added is preferably from 0.01 to 20.0 parts by mass, and is more preferably from 0.5 to 10.0 parts by mass, with respect to 100.0 parts by mass of the binder resin.

### [Method for Producing Toner Particle]

A method for producing the toner is not particularly limited, and a known method can be used such as a pulverization method, a suspension polymerization method, a dissolution suspension method, an emulsion aggregation method or a dispersion polymerization method. Here, it is preferable that the toner is produced by a method shown in the following. In other words, it is preferable that the toner is produced by an emulsion aggregation method.

The method for producing the toner includes the following steps (1) to (3):
(1) a dispersion step of preparing a binder-resin fine particle dispersion containing the binder resin;
(2) an aggregation step of forming an aggregated body by aggregating the binder resin fine particle contained in the binder-resin fine particle dispersion; and
(3) a fusion step of heating and fusing the aggregated body, in this order, wherein
in at least one of the aggregation step and the fusion step, a boric acid source is added.

In addition, it is preferable that the method includes the following steps (4) to (6), during or after the fusion step;
(4) a spheroidizing step of heating the aggregated body by further raising the temperature;
(5) a cooling step of cooling the aggregated body at a cooling rate of 0.1° C./see or higher; and
(6) an annealing step of heating and holding the aggregated body at a temperature of a crystallization temperature or higher, or a glass transition temperature of the binder resin or higher, in this order.

When the toner is produced by the emulsion aggregation method, a shape of the toner can be controlled, and boric acid tends to be easily dispersed uniformly in the vicinity of the surface of the toner, which is preferable. The details of the emulsion aggregation method will be described below.

### <Emulsion Aggregation Method>

The emulsion aggregation method is a method of: preparing an aqueous dispersion of fine particles formed of a constituent material of a toner particle which has a sufficiently small size with respect to a target particle size, in advance; aggregating the fine particles in an aqueous medium until the particle size of the toner particle is obtained; and fusing the resin by heating or the like to produce a toner particle.

Specifically, in the emulsion aggregation method, the toner particle is produced via: a dispersion step of producing a fine particle dispersion that is formed of a constituent material of the toner particle; an aggregation step of aggregating fine particles formed from the constituent material of the toner particle, and controlling a particle size until the particle size of the toner particle is obtained; a fusion step of fusing a resin contained in the obtained aggregated particle; a spheroidizing step of controlling a surface shape of the toner by melting the toner by heating or the like; a subsequent cooling step; a metal removal step of filtering the obtained toner and removing excessive polyvalent metal ions; a filtration and cleaning step of cleaning the resultant toner with ion-exchanged water or the like; and a step of removing a water content on the cleaned toner particle, and drying the resultant toner particle.

### [Step of Preparing Resin Fine Particle Dispersion (Dispersion Step)]

The resin fine particle dispersion can be prepared by a known method, but the method is not limited to these techniques. Examples of the known method include: an emulsion polymerization method; a self-emulsification method; a phase inversion emulsification method which adds an aqueous medium to a resin solution that dissolves the resin in an organic solvent, and thereby emulsifies the resin; and a forced emulsification method which does not use an organic solvent, subjects the resin to high-temperature treatment in an aqueous medium, and thereby forcibly emulsifies the resin.

Specifically, a binder resin is dissolved in an organic solvent which can dissolve the binder resin, and a surface-active agent or a basic compound is added thereto. At this time, if the binder resin is a crystalline resin having a melting point, the binder resin may be heated to the melting point or higher to be dissolved. Subsequently, an aqueous medium is slowly added while the resultant liquid is stirred with a homogenizer or the like, and a resin fine particle is caused to be deposited. After that, the solvent is removed by heating or pressure reduction, and thereby an aqueous dispersion of the resin fine particle is produced. As the organic solvent to be used for dissolving the resin, any organic solvent can be used as long as the solvent can dissolve the resin, but it is preferable to use an organic solvent which forms a homogeneous phase with water, such as toluene, from the viewpoint of suppressing the generation of a coarse powder.

The surface-active agent to be used at the time of the above emulsification is not particularly limited, but examples thereof include: anionic surface-active agents such as sulfate ester salt-based, sulfonate salt-based, carboxylate salt-based, phosphate ester-based, and soap-based surface-active agents; cationic surface-active agents such as an amine salt type and a quaternary ammonium salt type; and nonionic surface-active agents such as polyethylene glycol-based, alkylphenol ethylene oxide adduct-based and polyhydric alcohol-based surface-active agents. The surface-active agents may be used alone, or two or more types may be used in combination.

Examples of the basic compound to be used in the dispersion step include: inorganic bases such as sodium hydroxide and potassium hydroxide; and organic bases such as ammonia, triethylamine, trimethylamine, dimethylaminoethanol and diethylaminoethanol. The basic compound may be used alone, or two or more types may be used in combination.

In addition, it is preferable for a 50% particle size (D50) based on volume distribution of the fine particles of the binder resin in the aqueous dispersion of the resin fine particles to be from 0.05 to 1.0 μm, and is more preferable to be from 0.05 to 0.4 μm. Due to the 50% particle size (D50) based on volume distribution being adjusted to the above range, it becomes easy to obtain toner particle that has a volume-average particle size of from 3 to 10 μm, which is suitable as the toner particle.

The 50% particle size (D50) based on volume distribution is measured with the use of a dynamic light scattering particle size distribution analyzer Nanotrac UPA-EX150 (manufactured by Nikkiso Co., Ltd.).

### [Coloring Agent Fine Particle Dispersion]

A coloring agent fine particle dispersion may be used as needed. The coloring agent fine particle dispersion can be prepared by the known methods listed below, but the method is not limited to these techniques. The coloring agent fine particle dispersion can be prepared by mixing a coloring agent, an aqueous medium, and a dispersing agent, with a known mixing machine such as a stirring machine, an emulsifying machine or a dispersing machine. As the dispersing agent to be used here, a known dispersing agent such as a surface-active agent or a polymer dispersing agent can be used.

Both the surface-active agent and the polymer dispersing agent can be removed in a cleaning step which will be described later, but the surface-active agent is preferable from the viewpoint of cleaning efficiency.

Examples of the surface-active agent include anionic surface-active agents such as sulfate ester salt-based, sulfonate salt-based, phosphate ester-based, and soap-based surface-active agents; cationic surface-active agents such as an amine salt type and a quaternary ammonium salt type; and nonionic surface-active agents such as polyethylene glycol-based, alkylphenol-ethylene oxide adduct-based and polyhydric alcohol-based surface-active agents. Among the surface-active agents, nonionic surface-active agents or anionic surface-active agents are preferable. In addition, a nonionic surface-active agent and an anionic surface-active agent may be used in combination. The surface-active agent may be used alone, or two or more types may be used in combination. The concentration of the surface-active agent in the aqueous medium is preferably from 0.5 to 5%.

The content of the coloring agent fine particles in the coloring agent fine particle dispersion is not particularly limited, but is preferably from 1 to 30% with respect to the total mass of the coloring agent fine particle dispersion.

In addition, it is preferable that the dispersed particle size of the coloring agent fine particles in the aqueous dispersion of the coloring agent is 0.5 μm or smaller in terms of the 50% particle size (D50) based on volume distribution, from the viewpoint of the dispersibility of the coloring agent in the finally obtained toner. In addition, for the same reason, it is preferable that the dispersed particle size is 2 μm or smaller in terms of a 90% particle size (D90) based on volume distribution. The dispersed particle size of the coloring agent fine particles dispersed in the aqueous medium is measured by a dynamic light scattering particle size distribution analyzer (Nanotrac UPA-EX150, manufactured by Nikkiso Co., Ltd.).

Examples of a known mixing machine such as a stirring machine, an emulsifying machine or a dispersing machine, which is used when the coloring agent is dispersed in the aqueous medium, include an ultrasonic homogenizer, a jet mill, a pressure type homogenizer, a colloid mill, a ball mill, a sand mill and a paint shaker. These may be used singly or in combination.

### [Release Agent (Aliphatic Hydrocarbon Compound) Fine Particle Dispersion]

A release agent fine particle dispersion may be used as needed. The release agent fine particle dispersion can be prepared by the known methods listed below, but the method is not limited to these techniques.

The release agent fine particle dispersion can be prepared by operations of: adding a release agent to an aqueous medium containing a surface-active agent; heating the mixture to a temperature of a melting point of the release agent or higher; dispersing the mixture into a form of particles by a high-shear-imparting homogenizer (for example, “Crea MIx W Motion” manufactured by M Technique Co., Ltd.) or a pressure-discharge dispersing machine (for example, “GAULIN Homogenizer” manufactured by APV. GAULIN); and cooling the dispersion to a temperature lower than the melting point of the release agent.

It is preferable for a dispersed particle size of the release agent in the aqueous dispersion in the release agent fine particle dispersion to be from 0.03 to 1.0 μm, and is more preferable to be from 0.1 to 0.5 μm, in terms of the 50% particle size (D50) based on volume distribution. In addition, it is preferable that a coarse particle of 1 μm or larger does not exist.

Due to the dispersed particle size in the release agent fine particle dispersion being in the above range, the release agent can be finely dispersed in the toner to exist therein, and can cause a bleeding effect at the time of fixing to be exhibited to the maximum; and satisfactory separability can be obtained. The dispersed particle size in the release agent fine particle dispersion can be measured by a dynamic light scattering particle size distribution analyzer (Nanotrac UPA-EX150, manufactured by Nikkiso Co., Ltd.).

### [Mixing Step]

In a mixing step, a mixed liquid is prepared by mixing of the resin fine particle dispersion with, if necessary, at least one of the release agent fine particle dispersion and the coloring agent fine particle dispersion. The mixing can be performed with the use of a known mixing apparatus such as a homogenizer and a mixer.

### [Step of Forming Aggregated Particle (Aggregation Step)]

The aggregation step includes aggregating the fine particles contained in the mixed liquid which has been prepared in the mixing step, and forming an aggregated body having a target particle size. At this time, an aggregating agent is added and mixed, and at least one of heating and a mechanical power is appropriately applied as needed; and thereby an aggregated body is formed in which the resin fine particle is aggregated with at least one of the release agent fine particle and the coloring agent fine particle as needed.

Examples of the aggregating agent include: organic aggregating agents such as a cationic surface-active agent of a quaternary salt and polyethyleneimine; inorganic metal salts such as sodium sulfate, sodium nitrate, sodium chloride, calcium chloride and calcium nitrate: inorganic ammonium salts such as ammonium sulfate, ammonium chloride and ammonium nitrate; and inorganic aggregating agents such as divalent or higher valent metal complexes. In addition, an acid can also be added so as to lower the pH and cause soft aggregation, and for example, sulfuric acid, nitric acid or the like can be used.

The aggregating agent may be added in a form of any of a dry powder or an aqueous solution in which the aggregating agent is dissolved in an aqueous medium, but is preferably added in a form of the aqueous solution, in order to cause uniform aggregation. In addition, it is preferable that the aggregating agent is added and mixed at a temperature of the glass transition temperature or the melting point of the resin or lower which is contained in the mixed liquid. Due to the mixing performed under this temperature condition, the aggregation proceeds relatively uniformly. The aggregating agent can be mixed into the mixed liquid with the use of a known mixing apparatus such as a homogenizer or a mixer. The aggregation step is a step of forming the aggregated body having a toner particle size in an aqueous medium. It is preferable that a volume-average particle size of the aggregated body which is produced in the aggregation step is 3 μm to 10 μm. The volume-average particle size can be measured by a particle size distribution analysis apparatus (Coulter Multisizer III: manufactured by Beckman Coulter, Inc.) which uses the Coulter method.

### [Step of Obtaining Dispersion Containing Toner Particle (Fusion Step)]

In the fusion step, firstly, the aggregation is stopped in the dispersion containing the aggregated body which has been obtained in the aggregation step, in such a state that the dispersion is stirred as in the aggregation step. The aggregation is stopped by addition of an aggregation stopping agent of an inorganic salt compound or the like, such as a base which can adjust the pH, a chelate compound or sodium chloride.

After a dispersion state of the aggregated particles in the dispersion becomes stable by an action of the aggregation stopping agent, the binder resin is heated to a temperature of the glass transition temperature or the melting point thereof or higher, the aggregated particle is fused, and is adjusted to a desired particle size.

In addition, it is preferable that the 50% particle size (D50) based on volume of the toner particle is from 3 to 10 μm.

### [Step of Obtaining Desired Surface Shape of Toner (Spheroidizing Step)]

It is preferable that the toner particle is subjected to a spheroidizing step of further raising the temperature and keeping the toner particle until the toner particle has a desired circularity or a surface shape, during the fusion step or after the fusion step. It is preferable that the specific temperature of the spheroidizing step is, for example, 90° C. or higher, is preferably 92° C. or higher, and in addition, is preferably 95° C. or lower. Examples of the heating time period in the spheroidizing step includes 3 hours or longer, 5 hours or longer or 8 hours or longer. Due to the step, a hydrogen bond derived from boric acid tends to be easily formed in the toner particle.

### [Cooling Step]

It is preferable that the obtained dispersion is subjected to a cooling step of lowering the temperature of the dispersion containing the toner particle after the spheroidizing step to a temperature lower than a crystallizing temperature or a glass transition temperature of the binder resin at a controlled cooling rate. Due to being subjected to the cooling step, formation of asperities on the surface of the toner particle is suppressed, which accompanies a volumetric change such as expansion or shrinkage of the material in the toner particle, and accordingly, it becomes easy to control a shape factor SF1 (cross section) to from 105 to 125, and control a grounding area ratio (D/S) of the toner to 14% or smaller. In addition, due to the cooling rate being raised, the above volume change is further suppressed; and accordingly, the occurrence of dents on the toner particle surface can be suppressed, the desired circularity or surface shape obtained in the spheroidizing step can be maintained, the shape factor SF1 and the shape factor SF1 (cross section) of the toner can be controlled to 125 or smaller, and the grounding area ratio (D/S) of the toner can be controlled to 14% or smaller. The specific cooling rate is 0.1° C./see or higher, preferably 0.5° C./see or higher, more preferably 2° C./see or higher, and further preferably 4° C./see or higher.

### [Annealing Step]

It is preferable that the toner particle after the cooling step is subjected to an annealing step of heating and holding the toner particle at a temperature of the crystallization temperature or higher to the glass transition temperature or higher of the binder resin, and when the release agent is contained, to a temperature of the crystallization temperature of the release agent or lower. Due to being subjected to the annealing step, the above volume change is further suppressed, and accordingly the occurrence of dents on the surface of the toner particle can be suppressed. Accordingly, the annealing step can maintain the desired circularity or surface shape obtained through the cooling step, can control the shape factor SF1 and the shape factor SF1 (cross section) of the toner to 125 or smaller, and can control the grounding area ratio (D/S) of the toner to 14% or smaller. The specific annealing temperature is from 45 to 75° C., is preferably from 50 to 70° C., and is more preferably from 55 to 65° C. A heat treatment time period of the annealing step is, for example, 5 hours or shorter, and is preferably 2 to 3 hours.

### [Post-Treatment Step]

In the method for producing the toner, it is acceptable to further perform post-treatment steps such as a cleaning step, a solid-liquid separation step, and a drying step; and due to the post-treatment steps being performed, a toner particle in a dried state is obtained.

### [External Addition Step]

In the external addition step, the toner particle obtained in the drying step is subjected to external addition treatment with the strontium titanate particle according to the present invention and further with the titanium oxide particle. Furthermore, in addition to the particles, it is also preferable to add an inorganic fine particle such as silica, and resin fine particles of a vinyl resin, a polyester resin, a silicone resin and the like, while applying a shear force to the fine particles in a dry state, and mix the mixture.

### [Shell Layer Forming Step]

On the other hand, the method for producing the toner preferably includes a shell layer forming step of forming the aggregated particle (core particle) in the aggregation step, and then further adding a resin fine particle containing a resin for the shell, and aggregating the resultant mixture to form a shell layer. In other words, it is preferable that the toner particle has a core particle containing the binder resin and the shell layer on the surface of the core particle. As the resin for the shell, the same resin as the binder resin may be used, or another resin may be used. The amount of the resin for the shell to be added is preferably from 1 to 10 parts, and is more preferably from 2 to 7 parts, with respect to 100 parts by mass of the binder resin contained in the core particle.

In this case, it is preferable that the method for producing the toner includes the following steps.
(1) A dispersion step of preparing a binder-resin fine particle dispersion containing a binder resin;
(2-1) an aggregation step of aggregating the binder resin fine particles contained in the binder-resin fine particle dispersion to form an aggregated body;
(2-2) a shell forming step of further adding resin fine particles containing the resin for the shell to the dispersion containing the aggregated body, aggregating the resin fine particles, and forming an aggregated body having the shell; and
(3) a fusion step of heating and fusing the aggregated body.

Specifically, it is preferable that the above described aggregation step (2) (aggregation step of aggregating the binder resin fine particles contained in the binder-resin fine particle dispersion to form the aggregated body) includes the following steps (2-1) and (2-2):
(2-1) an aggregation step of aggregating the binder resin fine particles contained in the binder-resin fine particle dispersion to form the aggregated body; and
(2-2) a shell forming step of further adding resin fine particles containing the resin for the shell to the dispersion containing the aggregated body, and aggregating the resin fine particles to form the aggregated body having the shell.

In addition, it is more preferable that the method for producing the toner includes the following steps (4) to (6) in this order, in or after the fusion step:
(4) a spheroidizing step of heating the aggregated body by further raising the temperature;
(5) a cooling step of cooling the aggregated body at a cooling rate of 0.1° C./see or higher; and
(6) an annealing step of heating and holding the aggregated body at a temperature of the crystallization temperature or higher or the glass transition temperature of the binder resin or higher.

In order to facilitate boric acid to be contained in the vicinity of the surface of the toner particle, it is preferable to add a boric acid source to the dispersion containing the aggregated body together with the resin fine particle containing the resin for the shell, in the shell layer forming step.

The boric acid source may be boric acid, or a compound which can be converted into boric acid by pH control or the like while the toner is produced. Example thereof includes at least one selected from the group consisting of boric acid, borax, organic boric acid, a borate and a borate ester. For example, it is acceptable to add a boric acid source and control the boric acid so as to be contained in the aggregated body. Preferably, the pH is controlled to be acidic in the aggregation step (2-1), and the shell forming step is performed.

Boric acid may exist in the aggregated body in an unsubstituted state. The boric acid source is preferably at least one selected from the group consisting of boric acid and borax. When the toner is produced in an aqueous medium, it is preferable to add the boric acid source in a form of a borate, from the viewpoint of reactivity and production stability. Specifically, the boric acid source preferably includes at least one selected from the group consisting of sodium tetraborate, borax, ammonium borate and the like, and is further preferably borax.

Borax is indicated by decahydrate of sodium tetraborate (Na₂B₄O₇), and changes into boric acid in an acidic aqueous solution; and accordingly, when the boric acid source is used in an acidic environment in an aqueous medium, borax is preferably used. As an addition method, borax may be added in any form of a dry powder or an aqueous solution in which the borax is dissolved in an aqueous medium, but in order to cause uniform aggregation, it is preferable to add the borax in the form of an aqueous solution. The concentration of the aqueous solution may be appropriately changed according to the concentration to be included in the toner, and is, for example, 1 to 20% by mass. In order to convert the borax into boric acid, it is preferable to adjust a pH to an acidic condition, before addition, at the time of addition or after the addition. It is acceptable to control the pH, for example, to 1.5 to 5.0, and is preferable to control to 2.0 to 4.0.

### [Method for Measuring Physical Property]

Next, methods for measuring each physical property according to the present invention will be described.

<Method for Measuring Fragment Peaks Derived from Boron Atom and BO Structure>

The fragment peaks derived from the boron atom and the BO structure in the toner were detected with the use of TOF-SIMS.

TRIFT-IV manufactured by ULVAC-PHI, Inc. is used for the measurement of the fragment ions on the toner surface, in which TOF-SIMS is used. Analysis conditions are as follows.
Sample preparation: to attach toner particle to an indium sheet.
Primary ion: Au ion
Acceleration voltage: 30 kV
Charge neutralization mode: On
Measurement mode: Positive
Raster: 200 μm
Measurement time period: 60 s

It is confirmed whether a fragment ion derived from a boron atom is observed, from an obtained mass profile of secondary ion mass/secondary ion charge number (m/z). In the present invention, the presence or absence of the BO bond has been determined according to the presence or absence of the mass profile of the BO₂, in consideration of a balance with peak intensity.

### <Method for Measuring Primary Particle Size Based on Number, Maximum Feret's Diameter and Aspect Ratio of Titanium Oxide Particle>

The primary particle size based on number, the maximum Feret's diameter and the aspect ratio of the titanium oxide particle is calculated from an image of a titanium oxide particle on the toner surface, which is captured by a Hitachi ultra-high resolution field emission scanning electron microscope S-4800 (Hitachi High-Technologies Corporation). The image photographing conditions in S-4800 are as follows.
(1) Sample production

An electroconductive paste is applied thinly onto a sample stage (aluminum sample stage of 15 mm×6 mm), and a toner is sprayed on the paste. Furthermore, air is blown thereto to remove excess toner from the sample stage and the toner is sufficiently dried. The sample stage is set on a sample holder, and the height of the sample stage is adjusted to 36 mm by a sample height gauge.
(2) Setting of S-4800 observation conditions

The primary particle size based on number, the maximum Feret's diameter and the aspect ratio of the titanium oxide particle are calculated with the use of an image which has been obtained by observation of a reflected electron image of S-4800. The reflected electron image is less in charge-up of the titanium oxide particle than the secondary electronic image, and accordingly, the particle size of the titanium oxide particle can be measured with high accuracy.

Liquid nitrogen is injected into an anti-contamination trap which is attached to the housing of the S-4800, until the liquid nitrogen overflows, and the anti-contamination trap is left for 30 minutes. The “PC-SEM” in S-4800 is activated, and flushing (cleaning of the FE chip of the electron source) is performed. The acceleration voltage display portion of a control panel on the screen is clicked, a [Flushing] button is pressed, and a flushing execution dialog is opened. The flushing intensity is confirmed to be 2, and the flushing is executed. It is confirmed that the emission current due to the flushing is 20 to 40 μA. The sample holder is inserted into a sample chamber of the housing of S-4800. An [origin point] on the control panel is pressed to move the sample holder to the observation position.

An acceleration voltage display portion is clicked to open an HV setting dialog, and an acceleration voltage is set to [0.8 kV] and an emission current is set to [20 μA]. In a tab of [Basic] of an operation panel, a signal selection is set to [SE]; and [Upper (U)] and [+BSE] of an SE detector are selected, and [L.A. 100] is selected in a selection box on the right of [+BSE] to set a mode for observation with a reflected electron image. Similarly, in a tab of the [Basic] of the operation panel, the probe current is set to [Normal], the focus mode is set to [UHR], and WD is set to [3.0 mm] of an electron optical system condition block. The acceleration voltage is applied by pressing an [ON] button of the acceleration voltage display portion of the control panel.
(3) Focus adjustment

A portion inside the magnification display portion on the control panel is dragged to set the magnification to 100000 (100 k) times. A focus knob [COARSE] on the operation panel is rotated, and aperture alignment is adjusted when the focus has been attained to some extent. [Align] on the control panel is clicked to display the alignment dialog, and [Beam] is selected. The STIGMA/ALIGNMENT knobs (X, Y) on the operation panel are rotated to move a displayed beam to the center of the concentric circle. Next, [Aperture] is selected; and the STIGMA/ALIGNMENT knobs (X, Y) are turned one by one, and are adjusted so that the movement of the image stops or becomes minimal. The aperture dialog is closed, and the focus is adjusted by the autofocus. This operation is further repeated twice to adjust the focus.
(4) Image storage

Brightness is adjusted in an ABC mode; and the image is photographed into a size of 640×480 pixels, and is then stored. The following analysis is performed with the use of this image file. One photograph is taken for one titanium oxide particle, and images are obtained for at least 300 toner particles.
(5) Calculation of primary particle size based on number of titanium oxide particle

Primary particle sizes of 300 titanium oxide particles are measured to determine the primary particle size based on number. Here, the titanium oxide particle exists as an aggregated lump; and accordingly, the primary particle size based on number of the titanium oxide particle is obtained by operations of: determining the maximum diameters of particles which can be confirmed as the primary particle; and arithmetically averaging the obtained maximum diameters.
(6) Calculation of maximum Feret's diameter and aspect ratio of titanium oxide particle

The maximum Feret's diameter and the aspect ratio of the titanium oxide particle are calculated by analysis of the images of 300 titanium oxide particles which have been photographed in the image storage of the above (4), with the use of an image analysis software Image-Pro Plus ver. 5.0 (Nippon Roper Co., Ltd.). The analysis conditions of the image analysis software Image-Pro Plus ver. 5.0 are as follows.

### Software Image-ProPlus5.1J

The binarization conditions are set by selection of “count/size” and “option” in this order from “measurement” of the tool bar. In an object extraction option, an eight-connection is selected, and a smoothing is set to 0. In addition, a selection in advance, a filling of the blank, and an inclusion line are not selected, and “Exclusion of boundary line” is set to “None”. “Shape descriptors” and “Feret's diameter” are selected from the “Measurement” in the toolbar.

As for the calculation of the maximum Feret's diameter and the aspect ratio of the titanium oxide particle, the maximum Feret's diameter and the aspect ratio of the silica aggregated particle are obtained by automatic binarization, by “processing”-binarization.

Furthermore, it can be determined whether or not the external additive is titanium oxide, by combination with elemental analysis by an energy dispersive X-ray spectrometry (EDS). Specifically, the toner is observed in a field of view magnified up to 100,000 times with the use of a scanning electron microscope “S-4800” (trade name; manufactured by Hitachi, Ltd.). The surface of the toner particle is focused, and the external additive to be discriminated is observed. The external additive to be discriminated is subjected to EDS analysis, and it can be known whether or not the external additive is titanium oxide, from the element peak.

### <Quantitative Determination of Fatty Acid Existing on Surface of Strontium Titanate Particle>

The fatty acid existing on the surface of the strontium titanate particle was quantitatively determined with the use of the strontium titanate particle which was obtained by being separated from the toner surface and with the use of the GCMS method, as will be described below.
(1) Method for separating strontium titanate particle from toner surface

Sucrose (produced by Kishida Chemical Co., Ltd.) in an amount of 1.6 kg is added to ion-exchanged water in an amount of 1 L, and is dissolved while being heated in a hot water bath; and a sucrose concentrate is prepared. A dispersion is produced by charging of 31 g of the sucrose concentrate, 6 mL of Contaminon N (aqueous solution of 10% by mass of neutral detergent for cleaning precision measuring instruments, which has a pH of 7, includes nonionic surface-active agent, anionic surface-active agent and organic builder, and is produced by Fujifilm Wako Pure Chemical Corporation, Ltd.), into a centrifuge tube. The toner in an amount of 10 g is added to the dispersion, and a lump of the toner is disaggregated with a spatula or the like.

The centrifuge tube is set in “KM Shaker” (model: V. SX) manufactured by Iwaki Industry Co., Ltd., and is shaken for 20 minutes under a condition of 350 reciprocations per minute. After shaking, the solution is transferred to a glass tube for a swing rotor (50 mL), and is subjected to centrifugal separation in a centrifuge under conditions of 3500 rpm and for 30 minutes.

In the glass tube after the centrifugal separation, the toner particle exists in the uppermost layer, and an inorganic fine particle mixture containing the strontium titanate particle exists on an aqueous solution side of the lower layer. The aqueous solution of the lower layer is separated and then is dried, and an inorganic fine particle mixture is obtained. The above centrifugal separation step is repeated so that the total amount of the obtained inorganic fine particle mixture becomes 10 g or more.

Subsequently, 10 g of the obtained inorganic fine particle mixture is charged into a dispersion containing 100 mL of ion-exchanged water and 6 mL of Contaminon N, and is dispersed therein. The obtained dispersion is transferred to a glass tube for a swing rotor (50 mL), and is subjected to centrifugal separation in a centrifuge under conditions of 3500 rpm and for 30 minutes.

In the glass tube after the centrifugal separation, the strontium titanate particle exists in the lowermost layer, and another inorganic fine particle exists on an aqueous solution side of the upper layer.

The mixture of the inorganic fine particle containing the strontium titanate particle in the lowermost layer is collected, if necessary, a centrifugal separation operation is repeated, and the separation is sufficiently performed. After that, the strontium titanate particle is separated, and is dried; and the resultant strontium titanate particle is collected. The operation is repeated until a necessary amount of strontium titanate particles can be collected.
(2) Method for identifying fatty acid existing on surface of strontium titanate particle

Chloroform in an amount of 1 mL is added to the obtained strontium titanate particle in an amount of 0.05 g. An obtained sample solution is treated with an ultrasonic dispersion instrument for 10 minutes, and stearic acid is extracted into a chloroform solution.

Furthermore, the solid content is removed by centrifugal separation (model HITACHI himac CR22G, under condition of 12000 rpm) and filter filtration. The obtained solution is analyzed by GC-MS (gas chromatography-mass spectrometry).

The measurement conditions are specifically as follows.
GCMS apparatus: Trace1310 (manufactured by Thermo Fisher Scientific) and ISQ (manufactured by Thermo Fisher Scientific)
Column: HP-5 ms 30 m
Inlet temperature: 250° C.
Injected quantity: 1 μL
Column oven temperature: 40° C.→300° C. (15° C./min)
MS ionizing mode: EIIon source temperature: 250° C. Mass range: 35-800 m/z

A fatty acid existing on the surface of the strontium titanate is identified by operations of: analyzing a profile obtained by the analysis; comparing each of peak positions of a measurement sample with peak positions of the profiles obtained from the standard samples of fatty acids such as stearic acid; and further confirming the mass spectrum.

For example, when the fatty acid is stearic acid, several samples (for example, 200 ng, 300 ng, and 500 ng) of only standard samples of stearic acid are prepared, which have been precisely weighed, and are each measured under the above analysis conditions before the external additive sample is measured; and then, a calibration curve is created from the amount of charged stearic acid and the values of the stearic acid peak areas.

After that, a mass of the stearic acid is calculated from the surface area of the stearic acid components contained in 0.05 g of the strontium titanate particle, based on the calibration curve, and the content (% by mass) of the fatty acid existing on the surface of the strontium titanate particle was obtained.

When a plurality of fatty acids were contained, each fatty acid was identified and quantitatively determined.

### <Measurement of Abundance of Boron Atoms on Surface of Toner Particle>

A content of boron atoms on the surface of the toner particle is measured according to the following measurement method, with the use of an inductively coupled plasma mass spectrometry apparatus (ICP-MS (manufactured by Agilent Technologies Japan Ltd.)).
(a) An aqueous solution of 50% by mass of methanol in an amount of 20 g is added to the toner in an amount of 1 g, the mixture is shaken for 5 minutes at a shaking speed of 150 times per minute with the use of a shaker, and then the toner is taken out. This operation is repeated 10 times.
(b) An aqueous solution of 6.0 mol/L of nitric acid is prepared with the use of 60% nitric acid (produced by Kanto Chemical Co., Inc., Specification Ultrapur) and ultrapure water. A solution sample which contains the toner is produced by adding 5.00 g of 6.0 mol/L of nitric acid to 50.0 mg of the toner, and then mixing and stirring the mixture. The above sample is left to stand for 120 minutes, and boron atoms on the surface of the toner particle are extracted.
(c) The mixture is filtered through a filter paper having a pore size of 1 μm, a toner cake is produced, then, 10.00 g of ultrapure water is added as a washing water to the toner cake, and thus, the toner is separated from the solution sample containing the toner. A solution sample for boron atom measurement is produced by adding ultrapure water to the solution sample of the filtrate so that the total amount becomes 50.00 g.
(d) A content of boron atoms on the toner surface was measured by operations of: using an inductively coupled plasma mass spectrometry apparatus (ICP-MS); preparing a blank solution sample by adding ultrapure water to 5.00 g of an aqueous solution of 6.0 mol/L nitric acid so that the total amount becomes 50.00 g, and a solution sample of which the content of boron atom is known; creating a calibration curve; and quantitatively determining the boron atom contained in the sample for boron atom measurement.

### <Method for Measuring Thickness T of Shell Layer Existing on Surface of Toner Particle>

The portion is determined to be a shell layer, which does not contain a crystalline material in a region of 25% or shorter of a distance between the outline of the toner cross section and the centroid of the toner cross section, from the outline. The cross sections of 100 or more toners were observed, and an average value of the distances from the outline to the region which did not contain the crystalline material was calculated; and the value was determined to be the thickness of the shell layer.

### <Method for Measuring Molecular Weight of Polyester Resin>

A molecular weight of a polyester resin is measured by gel permeation chromatography (GPC) in the following way.

Firstly, the polyester resin is dissolved in tetrahydrofuran (THF) at room temperature. Then, the obtained solution is filtered through a solvent-resistant membrane filter “Maeshori disc” (manufactured by Tosoh Corporation) having a pore diameter of 0.2 μm, and a sample solution is obtained. The sample solution is adjusted so that the concentration of the components soluble in THF becomes 0.8% by mass. The sample solution is subjected to the measurement under the following conditions.
Apparatus: high-speed GPC apparatus “HLC-8220GPC” [manufactured by Tosoh Corporation]
Column: duplicate of LF-604
Eluent: THF
Flow rate: 0.6 ml/min
Oven temperature: 40° C.
Sample injection volume: 0.020 ml

When the molecular weight of the sample is calculated, the molecular weight calibration curve is used which has been prepared by use of standard polystyrene resins (for example, trade name “TSK standard polystyrene F-850, F-450, F-288, F-128, F-80, F-40, F-20, F-10, F-4, F-2, F-1, A-5000, A-2500, A-1000 and A-500”, produced by Tosoh Corporation).

### <Acid Value of Polyester Resin>

An acid value is the number of mg of potassium hydroxide required to neutralize an acid contained in 1 g of a sample.

The acid value in the present invention is measured according to JIS K0070-1992, and specifically, is measured according to the following procedure.

The sample is subjected to a titration which uses an ethyl alcohol solution of 0.1 mol/l potassium hydroxide (produced by Kishida Chemical Co., Ltd.). A factor of the above ethyl alcohol solution of potassium hydroxide can be determined with the use of a potentiometric titration apparatus (potentiometric titration measuring apparatus AT-510, manufactured by Kyoto Electronics Manufacturing Co., Ltd.). The factor is determined from the amount of the above ethyl alcohol solution of potassium hydroxide required for neutralization at the time when 100 ml of 0.100 mol/l hydrochloric acid is placed in a 250 ml tall beaker, and is titrated with the above ethyl alcohol solution of potassium hydroxide. The above 0.100 mol/l hydrochloric acid which is used is prepared according to JIS K8001-1998.

The measurement conditions for the acid value are shown below.
Titration apparatus: potentiometric titration apparatus AT-510 (manufactured by Kyoto Electronics Manufacturing Co., Ltd.)
Electrodes: composite glass electrode double-junction type (manufactured by Kyoto Electronics Manufacturing Co. Ltd.)
Control software for titration apparatus: AT-WIN
Titration analysis software: Tview

The titration parameter and control parameter in the titration are performed in the following way.
Titration parameter
Titration mode: blank titration
Titration mode: whole volume titration
Maximum titration amount: 20 ml
Waiting time period before titration: 30 seconds
Titration direction: automatic
Control parameter
End point determination potential: 30 dE
Potential value of end point determination: 50 dE/dmL
End point detection determination: not set
Control speed mode: standard
Gain: 1
Data collection potential: 4 mV
Data collection titration amount: 0.1 ml
Actual test: 0.100 g of a measurement sample is precisely weighed in a 250 ml tall beaker, and 150 ml of a mixed solution of toluene/ethanol (3:1) is added thereto; and the measurement sample is dissolved therein over 1 hour. The resultant measurement sample is titrated with the above ethyl alcohol solution of potassium hydroxide with the use of the above potentiometric titration apparatus.
Blank test: titration is performed in the same way as in the above operation, except that the sample is not used (in other words, only a mixed solution of toluene/ethanol (3:1) is used). The obtained result is substituted into the following Expression, and the acid value is calculated.

$$A = [ ( C - B ) \times f \times 5.611 ] / S$$

(wherein A: acid value (mgKOH/g), B: amount (ml) of ethyl alcohol solution of potassium hydroxide to be added in the blank test, C: amount (ml) of ethyl alcohol solution of potassium hydroxide to be added in the actual test, f: factor of potassium hydroxide solution, and S: sample (g).)

### <Method for Measuring Average Circularity of Toner (Particle)>

The average circularity of the toner or toner particle have been measured with a flow-type particle image analysis apparatus “FPIA-3000” (manufactured by Sysmex Corporation) under the measurement and analysis conditions at the time of calibration work.

A suitable amount of a surface-active agent and an alkylbenzene sulfonate is added to 20 mL of ion-exchanged water as a dispersing agent, and then, 0.02 g of a measurement sample is added thereto; and the mixture is subjected to dispersion treatment for 2 minutes with the use of a desktop type ultrasonic cleaner/dispersing machine (trade name: VS-150, manufactured by Velvo-Clear Co., Ltd.) having an oscillation frequency of 50 kHz and an electric output of 150 watts, and the resultant liquid is determined to be a dispersion for measurement. At this time, the dispersion is appropriately cooled so that the temperature becomes from 10° to 40° C.

For the measurement, the flow-type particle image analysis apparatus was used which was equipped with standard objective lens, and a particle sheath “PSE-900A” (produced by Sysmex Corporation) was used as a sheath liquid. The dispersion prepared according to the procedure is introduced into the flow-type particle image analysis apparatus, and 3000 toner particles are measured in an HPF measurement mode and a total count mode. Then, a binarization threshold value at the time of the particle analysis was set to 85%, the diameter of the particle to be analyzed was limited to a circle-equivalent diameter of from 1.98 μm to 19.92 μm, and the average circularity of the toner particle was determined.

In the measurement, automatic focus adjustment is performed with the use of standard latex particles (for example, “5100A” (product name) produced by Duke Scientific Corporation, which is diluted with ion-exchanged water) before the start of the measurement. After that, it is preferable to perform focus adjustment every two hours from the start of the measurement.

### <Measurement of Weight-Average Particle Size (D4) of Toner>

The weight-average particle size (D4) of the toner is calculated by operations of: using a precision particle size distribution measuring apparatus “Coulter Counter Multisizer 3” (registered trade mark, manufactured by Beckman Coulter, Inc.) which is equipped with an aperture tube of 100 μm and based on a pore electric resistance method, and an attached dedicated software “Beckman Coulter Multisizer 3 Version 3.51” (manufactured by Beckman Coulter, Inc.) for setting the measurement conditions and analyzing the measured data; measuring a particle size distribution through effective measurement channels of 25000 channels; and analyzing the measured data.

As an aqueous electrolyte solution to be used for the measurement, for example, “ISOTON II” (produced by Beckman Coulter, Inc.) can be used in which special-grade sodium chloride is dissolved in ion-exchanged water so that the concentration becomes about 1% by mass.

Note that before the measurement and analysis, the dedicated software is set in the following way.

In the “change standard measurement method (SOM)” screen of the dedicated software, the total count number of a control mode is set to 50,000 particles, the number of times of measurement is set to 1 and a value obtained by using standard particles each having a particle diameter of 10.0 μm (manufactured by Beckman Coulter, Inc.) is set as a Kd value. A threshold and a noise level are automatically set by pressing a threshold/noise level measurement button. In addition, a current is set to 1,600 μA, a gain is set to 2, an electrolyte solution is set to ISOTON II (product name) and a check mark is placed in a check box as to whether the aperture tube is flushed after the measurement.

In the “setting for conversion from pulse to particle diameter” screen of the dedicated software, a bin interval is set to a logarithmic particle diameter, the number of particle diameter bins is set to 256 and a particle diameter range is set to the range of from 2 to 60 μm.

A specific measurement method is as described below.
1. 200 mL of the electrolyte aqueous solution is charged into a 250 mL round-bottom beaker made of glass dedicated for the Multisizer 3. The beaker is set in a sample stand and the electrolyte aqueous solution in the beaker is stirred with a stirrer rod at 24 rotations/see in a counterclockwise direction. Then, dirt and bubbles in the aperture are removed by the “aperture tube flush” function of the analysis software.
2. 30 mL of the electrolyte aqueous solution is charged into a 100 mL flat-bottom beaker made of glass. 0.3 mL of a diluted solution prepared by diluting Contaminon N (a 10% by mass aqueous solution of a pH7 precision measuring device cleaning neutral detergent comprising a non-ionic surfactant, an anionic surfactant and an organic builder, manufactured by Wako Pure Chemical Industries, Ltd.) with ion-exchanged water by three mass fold is added to the electrolyte aqueous solution.
3. A predetermined amount of ion-exchanged water and 2 mL of Contaminon N (product name) are added into the water tank of an ultrasonic dispersing unit (product name: Ultrasonic Dispersion System Tetra 150, manufactured by Nikkaki Bios Co., Ltd.) having an electrical output of 120 W in which two oscillators each having an oscillatory frequency of 50 kHz are built so as to be under the state of being out of phase by 180º.
4. The beaker in the section (2) is set in the beaker fixing hole of the ultrasonic dispersing unit and the ultrasonic dispersing unit is operated. Then, the height position of the beaker is adjusted in order that the liquid surface of the electrolyte aqueous solution in the beaker may resonate with an ultrasonic wave from the ultrasonic dispersing unit to the fullest extent possible.
5. 10 mg of the toner is gradually added to and dispersed in the electrolyte aqueous solution in the beaker in the section (4) under a state in which the electrolyte aqueous solution is irradiated with the ultrasonic wave. Then, the ultrasonic dispersion treatment is continued for an additional 60 seconds. The temperature of water in the water tank is appropriately adjusted to from 10 to 40° C. in the ultrasonic dispersion.
6. The electrolyte aqueous solution in the section (5) in which the toner has been dispersed is added dropwise with a pipette to the round-bottom beaker in the section (1) placed in the sample stand and the concentration of the particles to be measured is adjusted to 5%. Then, measurement is performed until the particle diameters of 50,000 particles are measured.
7. The measurement data is analyzed with the dedicated software included with the apparatus and the weight-average particle diameter (D4) is calculated. An “average diameter” on the “analysis/volume statistics (arithmetic average)” screen of the dedicated software when the dedicated software is set to show a graph in a vol % unit is the weight-average particle diameter (D4).

### EXAMPLES

The present invention will be described in more detail with reference to the following Examples and Comparative Examples, but the present invention is not limited to the Examples at all. A part which is used in the Examples is based on mass unless otherwise specified.

### Production Example 1 of Strontium Titanate Particle

The metatitanic acid obtained by a sulfate method was subjected to a deironization and bleach treatment, and then an aqueous solution of sodium hydroxide was added to adjust the pH to 9.0; the mixture was subjected to desulfurization treatment, and after that, the resultant mixture was neutralized to a pH 5.8 with hydrochloric acid; and the resultant mixture was filtered, and the residue was washed with water. Water was added to the cleaned cake to form a slurry containing 1.85 mol/L of TiO₂, then hydrochloric acid was added to adjust the pH to 1.0, and the mixture was subjected to deflocculation treatment.

The metatitanic acid which had been desulfurized and deflocculated in an amount of 1.88 mol as TiO₂ was collected, and was charged into a reaction container of 3 L. To the deflocculated metatitanic acid slurry, an aqueous solution of 2.16 mol of strontium chloride was added so that an Sr/Ti molar ratio became 1.15, and then the mixture was adjusted to 1.015 mol/L by TiO₂ concentration. Next, the resultant mixture was heated to 90° C. while being stirred and mixed, and then 440 mL of an aqueous solution of 10 mol/L of sodium hydroxide was added thereto over 45 minutes; and then, the mixture was continuously stirred at 95ºC for 1 hour, and the reaction was finished.

The reaction slurry was cooled to 50° C., hydrochloric acid was added thereto until the pH became 5.0, and the mixture was continuously stirred for 20 minutes. The obtained precipitate was cleaned by decantation, was filtered and separated; and then, the residue was dried in the air at 120° ° C. for 8 hours.

Subsequently, 300 g of the dried product was charged into a Dry Particle Composing Machine (Nobilta NOB-130, manufactured by Hosokawa Micron Corporation). The dried product was subjected to pulverization treatment at a treatment temperature of 30° ° C. with a rotary treatment blade at 90 m/sec for 10 minutes. After that, the treated product was transferred to another container, hydrochloric acid was added thereto until the pH became 0.1, and the mixture was continuously stirred for 1 hour. The formed precipitate was cleaned by decantation.

The obtained slurry containing the precipitate was adjusted to 40° C., hydrochloric acid was added thereto, the pH of the mixture was adjusted to 2.5, and then 0.6 parts of stearic acid and 0.6 parts of palmitic acid with respect to 100 parts of the solid content were added thereto, and the mixture was continuously stirred and kept for 10 hours. A solution of 5 mol/L of sodium hydroxide was added thereto, the pH of the mixture was adjusted to 6.5, and the resultant mixture was continuously stirred for 1 hour. After that, the resultant mixture was filtered; the residue was cleaned, and was dried in the air at 120ºC for 8 hours; and a strontium titanate particle 1 (T-1) was obtained. The hydrophobicity of T-1 was 75 (% by volume), and an average primary particle size was 60 nm. Table 1 shows the surface treatment agent of T-1 and the amount of the added surface treatment agent.

### Production Examples 2 to 25 of Strontium Titanate Particle

Strontium titanate particles 2 to 25 (T-2 to T-25) were produced in the same way as in Production Example 1 of the strontium titanate particle, except that a formulation of the surface treatment agent was changed as shown in Table 1.

TABLE 1

| | Particle | | | | |
|---|---|---|---|---|---|
| Stron- | size of | | Added | | Added |
| tium | strontium | | amount | | amount |
| titanate | titanate | | (parts | | (parts |
| particle | particle | Treatment | by | Treatment | by |
| No. | [nm] | agent 1 | mass) | agent 2 | mass) |
| T-1 | 60 | Stearic acid (C18) | 0.6 | Palmitic | 0.6 |
| | | | | acid(C16) | |
| T-2 | 60 | Lignoceric acid | 0.6 | Lauric acid | 0.6 |
| | | (C24) | | (C12) | |
| T-3 | 60 | Stearic acid (C18) | 1.2 | — | — |
| T-4 | 60 | Lignoceric acid | 1.2 | — | — |
| | | (C24) | | | |
| T-5 | 60 | Myristic acid | 1.2 | — | — |
| | | (C14) | | | |
| T-6 | 60 | Lauric acid | 1.2 | — | — |
| | | (C12) | | | |
| T-7 | 60 | Melissic acid | 1.2 | — | — |
| | | (C30) | | | |
| T-8 | 60 | Caprylic acid | 1.2 | — | — |
| | | (C8) | | | |
| T-9 | 60 | C34 saturated | 1.2 | — | — |
| | | fatty acid (C34) | | | |
| T-10 | 60 | Stearic acid (C18) | 0.3 | — | — |
| T-11 | 60 | Stearic acid (C18) | 4.0 | — | — |
| T-12 | 60 | Stearic acid (C18) | 5.0 | — | — |
| T-13 | 60 | Stearic acid (C18) | 6.0 | — | — |
| T-14 | 60 | Stearic acid (C18) | 0.1 | — | — |
| T-15 | 60 | Stearic acid (C18) | 0.05 | — | — |
| T-16 | 60 | Stearic acid (C18) | 3.0 | — | — |
| T-17 | 60 | Stearic acid (C18) | 1.5 | — | — |
| T-18 | 60 | Stearic acid (C18) | 2.5 | — | — |
| T-19 | 60 | Stearic acid (C18) | 3.0 | — | — |
| T-20 | 60 | Stearic acid (C18) | 0.4 | — | — |
| T-21 | 60 | Stearic acid (C18) | 0.34 | — | — |
| T-22 | 60 | Stearic acid (C18) | 4.2 | — | — |
| T-23 | 60 | Stearic acid (C18) | 7.0 | — | — |
| T-24 | 60 | Stearic acid (C18) | 7.0 | — | — |
| T-25 | 60 | n-Octyltriethoxy- | 4.0 | — | — |
| | | silane | | | |

### Production Example of Titanium Oxide Particles 1 to 5

A titanium oxide particle was produced in the following way. To metatitanic acid obtained by a sulfate method, an aqueous solution of 50%-NaOH was added in an amount of 4 times the molar amount of TiO₂ as NaOH, and the mixture was heated at 95° C. for 2 hours. The resultant mixture was thoroughly washed, 31%-HCl was added to the mixture so that HCl/TiO₂ becomes 0.26, and the mixture was heated at the boiling point for 1 hour. After having been cooled, the resultant mixture was neutralized with 1 mol/L-NaOH to pH 7, then, the resultant liquid was washed and dried, and a fine particle titanium oxide was produced. A specific surface area of the obtained fine particle titanium oxide was 115 g/m².

To 100 parts of the fine particle titanium oxide, 100 parts of NaCl and 25 parts of Na₂P₂O_{7·10}H₂O were added, the mixture was mixed for 1 hour with a vibrating ball-mill, and the mixture was calcined for 2 hours at 850° C. in an electric oven. The obtained calcined product was charged into pure water; and the mixture was heated therein at 80° C. for 6 hours, and then was washed to remove a soluble salt therefrom. All the particles obtained by drying were fine particle titanium oxide particles 1 to 5 of which minor axes were in a range of from 0.03 to 0.07 μm, and major axes were in a range of from 0.4 to 0.8 μm. The physical properties of titanium oxide particles 1 to 5 (S-1 to S-5) are shown in Table 2.

TABLE 2
Physical property of titanium oxide particle

| | Maximum Feret's | |
|---|---|---|
| | diameter [nm] | Aspect ratio |
| S-1 | 1121 | 7.2 |
| S-2 | 843 | 5.1 |
| S-3 | 2867 | 6.5 |
| S-4 | 976 | 4.8 |
| S-5 | 3142 | 6.7 |

### <Synthesis of Polyester Resin 1>

| | |
|---|---|
| Bisphenol-A ethylene oxide 2-molar adduct | 10 parts by mol |
| Bisphenol-A propylene oxide 2-molar adduct | 94 parts by mol |
| Terephthalic acid | 50 parts by mol |
| Fumaric acid | 31 parts by mol |
| Dodecenyl succinic acid | 24 parts by mol |

The above monomers were charged into a flask equipped with a stirring apparatus, a nitrogen inlet tube, a temperature sensor and a rectifying column, the temperature was raised to 195° C. over 1 hour, and it was confirmed that the inside of the reaction system was uniformly stirred. To 100 parts of these monomers, 1.0 part of tin distearate was added. Furthermore, the temperature was raised from 195° ° C. to 250° C. over 5 hours while the formed water was distilled off, and the mixture was further subjected to a dehydration condensation reaction at 250° C. for 2 hours.

As a result, a polyester resin 1 was obtained of which the glass-transition temperature was 60.5° C., the acid value was 16.7 mgKOH/g, the hydroxyl value was 28.1 mgKOH/g, the weight-average molecular weight was 11300, and the number-average molecular weight was 4200.

### <Synthesis of Polyester Resin 2>

| | |
|---|---|
| Bisphenol-A ethylene oxide 2-molar adduct | 48 parts by mol |
| Bisphenol-A propylene oxide 2-molar adduct | 48 parts by mol |
| Terephthalic acid | 67 parts by mol |
| Dodecenyl succinic acid | 28 parts by mol |

The above monomers were charged into a flask equipped with a stirring apparatus, a nitrogen inlet tube, a temperature sensor and a rectifying column, the temperature was raised to 195° C. over 1 hour, and it was confirmed that the inside of the reaction system was uniformly stirred.

Tin distearate in an amount of 0.7 parts with respect to 100 parts of these monomers was added thereto. Furthermore, the temperature was raised from 195° C. to 240° C. over 5 hours while the formed water was distilled off, and the mixture was further subjected to a dehydration condensation reaction at 240° ° C. for 2 hours. Next, the temperature was lowered to 190° C., and 5 parts by mol of trimellitic anhydride was gradually charged, and the reaction was continued at 190° C. for 1 hour.

As a result, a polyester resin 2 was obtained of which the glass-transition temperature was 55.8° C., the acid value was 14.0 mgKOH/g, the hydroxyl value was 24.4 mgKOH/g, the weight-average molecular weight was 44000, and the number-average molecular weight was 6300.

### <Preparation of Resin Particle Dispersion 1>

| | |
|---|---|
| Polyester resin 1 | 100 parts |
| Methyl ethyl ketone | 50 parts |
| Isopropyl alcohol | 20 parts |

Methyl ethyl ketone and isopropyl alcohol were charged into a container. After that, the polyester resin 1 was gradually charged and completely dissolved by stirring, and a solution of a polyester resin 1 was obtained.

The container containing the solution of the polyester resin 1 was set to 65° C., and while the solution was stirred, an aqueous solution of 10% ammonium was gradually added dropwise so that the total amount became 5 parts; and furthermore, 230 parts of ion-exchanged water was gradually added dropwise thereto at a rate of 10 ml/min, and the polyester resin 1 was phase-inversion emulsified. Furthermore, a solvent was removed by pressure reduction of the emulsified liquid with an evaporator, and a resin particle dispersion 1 of the polyester resin 1 was obtained. A volume-average particle size of the resin particles was 135 nm. In addition, the solid content of the resin particle was adjusted to 20% with ion-exchanged water.

### <Preparation of Resin Particle Dispersion 2>

| | |
|---|---|
| Polyester resin 2 | 100 parts |
| Methyl ethyl ketone | 50 parts |
| Isopropyl alcohol | 20 parts |

Methyl ethyl ketone and isopropyl alcohol were charged into a container. After that, the above materials were gradually charged into the container, and were completely dissolved by stirring; and a solution of the polyester resin 2 was obtained. The container containing the solution of the polyester resin 2 was set to 40° C., and while the solution was stirred, an aqueous solution of 10% ammonium was gradually added dropwise so that the total amount became 3.5 parts; and furthermore, 230 parts of ion-exchanged water was gradually added dropwise thereto at a rate of 10 ml/min, and the polyester resin 2 was phase-inversion emulsified. Furthermore, a solvent was removed by pressure reduction of the emulsified liquid, and a resin particle dispersion 2 of the polyester resin 2 was obtained. The volume-average particle size of the resin particles was 155 nm. In addition, the solid content of the resin particle was adjusted to 20% with ion-exchanged water.

### <Preparation of Coloring-Agent Particle Dispersion>

| | |
|---|---|
| Copper phthalocyanine (Pigment Blue 15:3) | 45 parts |
| Ionic surface-active agent NEOGEN RK | 5 parts |
| (produced by Dai-ichi Kogyo Seiyaku Co., Ltd.) | |
| Ion-exchanged water | 190 parts |

The above components were mixed and dispersed for 10 minutes with the use of a homogenizer (Ultra-Turrax® manufactured by IKA-Werke), and then the mixture was subjected to dispersion treatment for 20 minutes at a pressure of 250 MPa with the use of an Ultimizer (counter-impingement type wet grinder: manufactured by Sugino Machine Limited); and a coloring-agent particle dispersion was obtained of which the volume-average particle size of coloring-agent particles was 120 nm and the solid content was 20%.

### <Preparation of Release Agent Particle Dispersion>

| | |
|---|---|
| Release agent (hydrocarbon wax, and melting | 15 parts |
| temperature: 79° C.) | |
| Ionic surface-active agent NEOGEN RK | 2 parts |
| (produced by Dai-ichi Kogyo Seiyaku Co., Ltd.) | |
| Ion-exchanged water | 240 parts |

The above materials were heated to 100° C., were thoroughly dispersed with the use of Ultra-Turrax® T50 manufactured by IKA-Werke, and then the mixture was heated to 115° C. with the use of a pressure discharge type Gorlin homogenizer and was subjected to dispersion treatment for 1 hour; and a release agent particle dispersion was obtained of which the volume-average particle size was 160 nm and the solid content was 20%.

### Production Example of Toner Particle 1

| | |
|---|---|
| Resin particle dispersion 1 | 500 parts |
| Resin particle dispersion 2 | 400 parts |
| Colorant particle dispersion | 50 parts |
| Release agent particle dispersion | 80 parts |

Firstly, as a core forming step, each of the above materials was charged into a round bottom flask made from stainless steel, and was mixed with the other. Subsequently, the mixture was dispersed with the use of a homogenizer Ultra-Turrax® T50 (manufactured by IKA-Werke), at 5000 r/min for 10 minutes. An aqueous solution of 1.0% nitric acid was added thereto, and a pH of the resultant mixture was adjusted to 3.0; and the resultant mixture was heated to 58° C. in a heating water bath, while such a number of rotations was appropriately adjusted that the mixed liquid was stirred with the use of a stirring blade.

A volume-average particle size of the formed aggregated particles was appropriately checked with the use of a Coulter Multisizer III; when aggregated particles (cores) having a volume-average particle size of 5.0 μm were formed, the following materials were each charged thereto as the shell layer forming step, and the mixture was further stirred for 1 hour; and a shell layer was formed.

| | |
|---|---|
| Resin Particle Dispersion 1 | 40 parts |
| Ion-exchanged water | 300 parts |
| Aqueous solution of 10.0% by mass of borax | 20 parts |
| (Borax; sodium tetraborate decahydrate produced | |
| by Fuji Film Wako Pure Chemical Corporation) | |

After that, as a spheroidizing step, the pH was adjusted to 9.0 with the use of an aqueous solution of 5% sodium hydroxide, and the mixture was heated to 92° C. while stirring was continued.

When a desired surface shape was obtained, heating was stopped; as a cooling step, ice was quickly charged so that a cooling rate became 10° C./see or higher, and the mixture was cooled to 40° C.; and furthermore, as an annealing step, the mixture was subjected to annealing treatment at 55° C. for 3 hours.

After that, the mixture was cooled to 25° C., was filtered and was subjected to solid-liquid separation; and then the residue was cleaned with ion-exchanged water. After the cleaning was finished, the cleaned product was dried with the use of a vacuum drying machine, and a toner particle 1 (B-1) was obtained of which the weight-average particle size (D4) was 6.7 μm.

### Production Examples of Toner Particles 2 to 4, 9 to 11 and 15

Toner particles 2 to 4, 9 to 11 and 15 (B-2 to 4, 9 to 11 and 15) were obtained by the same method as in the production example of the toner particle 1, except that the formulation and conditions were changed to those shown in Table 3. The physical properties of the obtained toner particles 2 to 4, 9 to 11 and 15 are shown in Tables 4-1 and 4-2.

### <Toner Particles 5 to 8>

Toner particles 5 to 8 were obtained in the same way as in the Production Example of the toner particle 2, except that the conditions in the spheroidizing step were adjusted so that the circularity of the toner particle to be obtained became a desired value in the Production Example of the toner particle 2. Tables 4-1 and 4-2 show the physical properties of the obtained toner particles 5 to 8.

### Production Examples of Toner Particles 12 to 14

Toner particles 12 to 14 (B-12 to 14) were obtained in the same way as in the production of the toner particle 11, except that the amount of boron in the toner to be obtained was changed by spray of an aqueous solution of boric acid onto the toner particle 11 as shown in Table 3. The physical properties of the obtained toner particles 12 to 14 are shown in Tables 4-1 and 4-2.

### <Toner Particle 16>

A toner particle 16 was obtained in the same way as in the Production Example of the toner particle 7, except that in the Production Example of the toner particle 7, the formulation of the shell layer forming step was changed as shown in Table 3. The physical properties of the obtained toner particle 16 are shown in Tables 4-1 and 4-2.

### <Toner Particle 17>

A toner particle 17 was obtained in the same way as in the Production Example of the toner particle 8, except that in the Production Example of the toner particle 7, the formulation of the shell layer forming step was changed as shown in Table 3. The physical properties of the obtained toner particle 17 are shown in Tables 4-1 and 4-2.

### Production Example of Toner Particle 18

The following materials were adequately mixed with an FM mixer (manufactured by Nippon Coke & Engineering Co., Ltd.), and then were melted and kneaded with a twin-screw kneader (manufactured by Ikegai Corp.) which was set at a temperature of 100° C.

| | |
|---|---|
| Polyester resin 2 | 95.0 parts |
| Polyester resin 1 | 5.0 parts |
| HNP9 (melting temperature: 76° C., and produced | 5.0 parts |
| by Nippon Seiro Co., Ltd.) | |
| C.I. Pigment Blue15:3 | 6.0 parts |

The obtained kneaded product was cooled, and was coarsely pulverized to 1 mm or smaller by a hammermill; and a coarsely pulverized product was obtained.

Next, the obtained coarsely pulverized powder was pulverized into a finely pulverized powder of about 5 μm with the use of a turbo mill manufactured by Freund-Turbo Corporation, and then furthermore, the fine coarse powder was cut with the use of a multi-division classifying machine which utilizes the Coanda effect; and the amount of boric acid in the toner to be obtained was adjusted so as to become the value shown in Tables 4-1 and 4-2 by the spray of the aqueous solution of boric acid as shown in Table 3, and a toner particle 18 (B-18) was obtained.

The weight-average particle size (D4) of the toner particle 18 was 6.7 μm, and Tg thereof was 58.4° C.

TABLE 3

| | | Shell layer forming step | | | | |
|---|---|---|---|---|---|---|
| | | Boric acid component | | Resin particle dispersion | | |
| | | | Added | | Added | |
| Toner | | | amount | | amount | Additional |
| particle | Average | | [parts by | | [parts by | spray of |
| No. | circularity | Type | mass] | Type | mass] | boric acid |
| B-1 | 0.978 | 10.0 mass % borax | 20 | Resin particle | 40.0 | None |
| | | aqueous solution | | dispersion 1 | | |
| B-2 | 0.978 | 10.0 mass % borax | 10 | Resin particle | 40.0 | None |
| | | aqueous solution | | dispersion 1 | | |
| B-3 | 0.978 | 10.0 mass % borax | 60 | Resin particle | 40.0 | None |
| | | aqueous solution | | dispersion 1 | | |
| B-4 | 0.978 | 10.0 mass % borax | 20 | Resin particle | 40.0 | None |
| | | aqueous solution | | dispersion 1 | | |
| B-5 | 0.960 | 10.0 mass % borax | 10 | Resin particle | 40.0 | None |
| | | aqueous solution | | dispersion 1 | | |
| B-6 | 0.990 | 10.0 mass % borax | 10 | Resin particle | 40.0 | None |
| | | aqueous solution | | dispersion 1 | | |
| B-7 | 0.955 | 10.0 mass % borax | 10 | Resin particle | 40.0 | None |
| | | aqueous solution | | dispersion 1 | | |
| B-8 | 0.992 | 10.0 mass % borax | 10 | Resin particle | 40.0 | None |
| | | aqueous solution | | dispersion 1 | | |
| B-9 | 0.978 | 10.0 mass % borax | 5 | Resin particle | 40.0 | None |
| | | aqueous solution | | dispersion 1 | | |
| B-10 | 0.978 | 10.0 mass % borax | 3 | Resin particle | 40.0 | None |
| | | aqueous solution | | dispersion 1 | | |
| B-11 | 0.978 | 20.0 mass % borax | 80 | Resin particle | 40.0 | None |
| | | aqueous solution | | dispersion 1 | | |
| B-12 | 0.978 | 20.0 mass % borax | 80 | Resin particle | 40.0 | Yes |
| | | aqueous solution | | dispersion 1 | | |
| B-13 | 0.978 | 20.0 mass % borax | 80 | Resin particle | 40.0 | Yes |
| | | aqueous solution | | dispersion 1 | | |
| B-14 | 0.978 | 20.0 mass % borax | 80 | Resin particle | 40.0 | Yes |
| | | aqueous solution | | dispersion 1 | | |
| B-15 | 0.978 | None | — | Resin particle | 40.0 | None |
| | | | | dispersion 1 | | |
| B-16 | 0.955 | 10.0 mass % borax | 10 | Resin particle | 20.0 | None |
| | | aqueous solution | | dispersion 1 | | |
| B-17 | 0.992 | 10.0 mass % borax | 10 | Resin particle | 50.0 | None |
| | | aqueous solution | | dispersion 1 | | |
| B-18 | 0.955 | None | — | None | — | Yes |

### Production Example of Toner 1

External addition was performed on the above toner particle 1 (B-1). With the use of an FM mixer (FM10 manufactured by Nippon Coke & Engineering Co., Ltd.), respective materials were added to 2.7 kg of the toner particle 1 (B-1) so that the toner to be obtained had 1.0% by mass of a silica fine particle 1 (silica particle which is treated with dimethyl silicone oil and had BET specific surface area of 150 m²/g), had 0.3% by mass of strontium titanate particle 1 (T-1), and 0.1% by mass of titanium oxide particle 1 (S-1) with respect to the toner particle 1.

After that, the mixture was mixed for 5 minutes at 3000 rpm; and thus, the external addition was performed. At this time, a flow rate and a temperature of cold water which was flowed to a cooling jacket were controlled, and thereby, the temperature inside the tank after 5 minutes of mixing was adjusted so as to become 35° C.

After that, the toner was sieved with a mesh having an opening of 75 μm, and a toner 1 was obtained. The physical properties of the toner 1 are shown in Tables 4-1 and 4-2.

### Production Examples of Toners 2 to 47

Toners 2 to 47 were obtained by performing the same operation as in the Production Example of the toner 1, except that a type of a toner particle, a type and an amount of an added strontium titanate particle and a type of a titanium oxide particle were changed. The physical properties of the obtained toners 2 to 47 are shown in Tables 4-1 and 4-2.

TABLE 4-1

| | | | Thickness | Fragment peak | Content X of | |
|---|---|---|---|---|---|---|
| | Toner | | of shell | derived from | boron atom | Strontium |
| Toner | particle | Average | layer | BO structure | in toner | titanate |
| No. | No. | circularity | [nm] | are detected | (ppm) | particle No. |
| Toner 1 | B-1 | 0.978 | 443 | Yes | 1.0 | T-1 |
| Toner 2 | B-1 | 0.978 | 443 | Yes | 1.0 | T-2 |
| Toner 3 | B-2 | 0.978 | 456 | Yes | 0.3 | T-3 |
| Toner 4 | B-3 | 0.978 | 470 | Yes | 2.0 | T-3 |
| Toner 5 | B-4 | 0.978 | 510 | Yes | 1.0 | T-3 |
| Toner 6 | B-5 | 0.960 | 410 | Yes | 0.3 | T-4 |
| Toner 7 | B-6 | 0.990 | 579 | Yes | 0.3 | T-5 |
| Toner 8 | B-7 | 0.955 | 383 | Yes | 0.3 | T-3 |
| Toner 9 | B-8 | 0.992 | 603 | Yes | 0.3 | T-3 |
| Toner 10 | B-2 | 0.978 | 456 | Yes | 0.3 | T-6 |
| Toner 11 | B-2 | 0.978 | 456 | Yes | 0.3 | T-7 |
| Toner 12 | B-2 | 0.978 | 456 | Yes | 0.3 | T-8 |
| Toner 13 | B-2 | 0.978 | 456 | Yes | 0.3 | T-9 |
| Toner 14 | B-2 | 0.978 | 456 | Yes | 0.3 | T-10 |
| Toner 15 | B-2 | 0.978 | 456 | Yes | 0.3 | T-11 |
| Toner 16 | B-2 | 0.978 | 456 | Yes | 0.3 | T-12 |
| Toner 17 | B-2 | 0.978 | 456 | Yes | 0.3 | T-13 |
| Toner 18 | B-2 | 0.978 | 456 | Yes | 0.3 | T-14 |
| Toner 19 | B-2 | 0.978 | 456 | Yes | 0.3 | T-15 |
| Toner 20 | B-9 | 0.978 | 436 | Yes | 0.1 | T-16 |
| Toner 21 | B-10 | 0.978 | 475 | Yes | 0.1 | T-17 |
| Toner 22 | B-10 | 0.978 | 475 | Yes | 0.1 | T-18 |
| Toner 23 | B-10 | 0.978 | 475 | Yes | 0.1 | T-19 |
| Toner 24 | B-10 | 0.978 | 475 | Yes | 0.1 | T-19 |
| Toner 25 | B-10 | 0.978 | 475 | Yes | 0.1 | T-19 |
| Toner 26 | B-11 | 0.978 | 426 | Yes | 5.0 | T-20 |
| Toner 27 | B-11 | 0.978 | 426 | Yes | 5.0 | T-21 |
| Toner 28 | B-11 | 0.978 | 426 | Yes | 5.0 | T-10 |
| Toner 29 | B-11 | 0.978 | 426 | Yes | 5.0 | T-22 |
| Toner 30 | B-12 | 0.978 | 420 | Yes | 70.0 | T-13 |
| Toner 31 | B-13 | 0.978 | 427 | Yes | 100.0 | T-23 |
| Toner 32 | B-13 | 0.978 | 427 | Yes | 100.0 | T-23 |
| Toner 33 | B-13 | 0.978 | 427 | Yes | 100.0 | T-23 |
| Toner 34 | B-14 | 0.978 | 435 | Yes | 120.0 | T-24 |
| Toner 35 | B-2 | 0.978 | 456 | Yes | 0.3 | T-9 |
| Toner 36 | B-2 | 0.978 | 456 | Yes | 0.3 | T-9 |
| Toner 37 | B-2 | 0.978 | 456 | Yes | 0.3 | T-9 |
| Toner 38 | B-2 | 0.978 | 456 | Yes | 0.3 | T-9 |
| Toner 39 | B-2 | 0.978 | 456 | Yes | 0.3 | T-9 |
| Toner 40 | B-16 | 0.955 | 301 | Yes | 0.3 | T-3 |
| Toner 41 | B-17 | 0.992 | 698 | Yes | 0.3 | T-3 |
| Toner 42 | B-18 | 0.955 | 0 | Yes | 0.3 | T-3 |
| Toner 43 | B-15 | 0.978 | 433 | None | 0 | T-1 |
| Toner 44 | B-1 | 0.978 | 443 | Yes | 1.0 | T-25 |
| Toner 45 | B-1 | 0.978 | 443 | Yes | 1.0 | None |
| Toner 46 | B-18 | 0.955 | 0 | Yes | 0.3 | None |
| Toner 47 | B-1 | 0.978 | 443 | Yes | 1.0 | None |

TABLE 4-2

| | | | Content Y of | Content Z (% by mass) of | | | |
|---|---|---|---|---|---|---|---|
| | | | strontium | fatty acid having from 12 to | | | |
| | | | titanate | 30 carbon atoms existing on | | | Titanium |
| Toner | | | particle | surface of strontium titanate | X/Y | X/Z | oxide |
| No. | Treatment agent 1 | Treatment agent 2 | (% by mass) | particle (% by mass) | value | value | particle No. |
| Toner 1 | C18 | C16 | 0.3 | 1.2 | 3.3 | 0.8 | S-1 |
| Toner 2 | C24 | C12 | 1.5 | 1.2 | 0.7 | 0.8 | S-1 |
| Toner 3 | C18 | None | 0.3 | 1.2 | 1.0 | 0.3 | S-1 |
| Toner 4 | C18 | None | 0.1 | 1.2 | 20.0 | 1.7 | S-1 |
| Toner 5 | C18 | None | 0.05 | 1.2 | 20.0 | 0.8 | S-1 |
| Toner 6 | C24 | None | 0.3 | 1.2 | 1.0 | 0.3 | S-1 |
| Toner 7 | C14 | None | 0.3 | 1.2 | 1.0 | 0.3 | S-1 |
| Toner 8 | C18 | None | 0.3 | 1.2 | 1.0 | 0.3 | S-1 |
| Toner 9 | C18 | None | 0.3 | 1.2 | 1.0 | 0.3 | S-1 |
| Toner 10 | C12 | None | 0.3 | 1.2 | 1.0 | 0.3 | S-1 |
| Toner 11 | C30 | None | 0.3 | 1.2 | 1.0 | 0.3 | S-1 |
| Toner 12 | C8 | None | 0.3 | 1.2 | 1.0 | 0.3 | S-1 |
| Toner 13 | C34 | None | 0.3 | 1.2 | 1.0 | 0.3 | S-1 |
| Toner 14 | C18 | None | 0.3 | 0.3 | 1.0 | 1.0 | S-1 |
| Toner 15 | C18 | None | 0.3 | 4.0 | 1.0 | 0.1 | S-1 |
| Toner 16 | C18 | None | 0.3 | 5.0 | 1.0 | 0.1 | S-1 |
| Toner 17 | C18 | None | 0.3 | 6.0 | 1.0 | 0.1 | S-1 |
| Toner 18 | C18 | None | 0.3 | 0.1 | 1.0 | 3.0 | S-1 |
| Toner 19 | C18 | None | 0.3 | 0.05 | 1.0 | 6.0 | S-1 |
| Toner 20 | C18 | None | 0.3 | 3.0 | 0.3 | 0.033 | S-1 |
| Toner 21 | C18 | None | 0.3 | 1.5 | 0.2 | 0.033 | S-1 |
| Toner 22 | C18 | None | 0.3 | 2.5 | 0.2 | 0.020 | S-1 |
| Toner 23 | C18 | None | 0.3 | 3.0 | 0.2 | 0.017 | S-1 |
| Toner 24 | C18 | None | 0.5 | 3.0 | 0.1 | 0.017 | S-1 |
| Toner 25 | C18 | None | 0.7 | 3.0 | 0.07 | 0.017 | S-1 |
| Toner 26 | C18 | None | 0.3 | 0.4 | 16.7 | 12.5 | S-1 |
| Toner 27 | C18 | None | 0.3 | 0.34 | 16.7 | 14.7 | S-1 |
| Toner 28 | C18 | None | 0.3 | 0.3 | 16.7 | 16.7 | S-1 |
| Toner 29 | C18 | None | 2.8 | 4.2 | 1.8 | 1.2 | S-1 |
| Toner 30 | C18 | None | 2.8 | 6.0 | 25.0 | 11.7 | S-1 |
| Toner 31 | C18 | None | 4.0 | 7.0 | 25.0 | 14.3 | S-1 |
| Toner 32 | C18 | None | 3.4 | 7.0 | 29.4 | 14.3 | S-1 |
| Toner 33 | C18 | None | 3.1 | 7.0 | 32.3 | 14.3 | S-1 |
| Toner 34 | C18 | None | 3.4 | 7.0 | 35.3 | 17.1 | S-1 |
| Toner 35 | C34 | None | 0.3 | 1.2 | 1.0 | 0.3 | S-2 |
| Toner 36 | C34 | None | 0.3 | 1.2 | 1.0 | 0.3 | S-3 |
| Toner 37 | C34 | None | 0.3 | 1.2 | 1.0 | 0.3 | S-4 |
| Toner 38 | C34 | None | 0.3 | 1.2 | 1.0 | 0.3 | S-5 |
| Toner 39 | C34 | None | 0.3 | 1.2 | 1.0 | 0.3 | None |
| Toner 40 | C18 | None | 0.3 | 1.2 | 1.0 | 0.3 | S-1 |
| Toner 41 | C18 | None | 0.3 | 1.2 | 1.0 | 0.3 | S-1 |
| Toner 42 | C18 | None | 0.3 | 1.2 | 1.0 | 0.3 | S-1 |
| Toner 43 | C18 | C16 | 0.3 | 1.2 | 0.0 | 0.0 | S-1 |
| Toner 44 | None (n- | None (n- | 0.3 | None (n- | 3.3 | — | S-1 |
| | Octyltriethoxysilane) | Octyltriethoxysilane) | | Octyltriethoxysilane) | | | |
| Toner 45 | None | None | 0 | 0 | — | — | S-1 |
| Toner 46 | None | None | 0 | 0 | — | — | S-1 |
| Toner 47 | None | None | 0 | 0 | — | — | S-1 |

### Examples 1 to 42 and Comparative Examples 1 to 5

The above toners 1 to 42 for Examples and toners 43 to 47 for Comparative Examples were each subjected to the following evaluation tests. The evaluation results are shown in Tables 5-1 to 5-4.

### Evaluation Apparatus:

HP LaserJet Enterprise Color M555dn which is a color laser printer equipped with a cleaning system with a one component toner contact developing blade and HP212X Black Toner Cartridge (W2120X) CRG which is a consumable cartridge thereof were modified and used.

The main body was modified so that a process speed became 150% and a printing test could be performed only at a black station. In addition, the cartridge was modified so that the volume of the toner container became as twice the normal volume, and so as to be capable of evaluating the durability. Thereby, the durability evaluation of a longer life could be performed in the main body of a higher speed than before.

<Evaluation 1. Halftone Density Difference after Durability Evaluation Under Low-Temperature and Low-Humidity Environment>

The main body of the printer and the toner cartridge filled with 400 g of an evaluation toner were left to stand in an environment of 15° C. and 10% RH for 24 hours, for the purpose of being adjusted to a temperature and a humidity of the evaluation environment. After the standing, similarly under the low-temperature and low-humidity environment, the durability evaluation was performed in which a horizontal line image having a printing rate of 1.5% and a margin of 5 mm was output on 30,000 sheets as two sheets per one job, with the use of a LETTER size of Vitality (LTR 75 g/m²) manufactured by XEROX.

After that, as the 30,001st sheet, a halftone image having a printing rate of 23%, a margin of 23%, and a margin of 5 mm was output on one sheet (halftone image 1).

After that, a charging roller was replaced with a new one, and then a halftone image having a printing rate of 23% was output on one sheet as the 30,002nd sheet (halftone image 2).

With the use of a portable spectrophotometer Exact Advance (X-Rite), image densities of the halftone images 1 and 2 were measured at 5 points, at 50 mm intervals from the leading edge of the paper in a longitudinal direction from the leading edge to the trailing edge of the paper, in three rows of a center row, a row 20 mm apart from the left edge, and a row 20 mm apart from the right edge, and 15 points in total, respectively.

The density difference (difference between the maximum value and the minimum value measured at 15 points) was obtained for each of the halftone images 1 and 2, and then the difference between the density difference of the halftone image 1 and the density difference of the halftone image 2 was calculated, and the halftone density difference due to the charging roller contamination after the durability evaluation was determined.

As the toner less causes the contamination of the charging roller, a halftone image having a density difference equivalent to that of a new charging roller can be output, and accordingly, the halftone density difference due to the contamination of the charging roller after the durability evaluation becomes smaller. Then, evaluation was made according to the following criteria.
(Halftone density difference due to charging roller contamination after durability evaluation)
A. The halftone density difference is less than 0.05.
B. The halftone density difference is 0.05 or more and less than 0.10.
C. The halftone density difference is 0.10 or more and less than 0.15.
D. The halftone density difference is 0.15 or more.
   <Evaluation 2. Solid Density Uniformity after Durability Evaluation Under Low-Temperature and Low-Humidity Environment>

The main body of the printer and the toner cartridge filled with 400 g of an evaluation toner were left to stand in an environment of 15° C. and 10% RH for 24 hours, for the purpose of being adjusted to a temperature and a humidity of the evaluation environment. After the standing, similarly under the low-temperature and low-humidity environment, the durability evaluation was performed in which a horizontal line image having a printing rate of 1.5% and a margin of 5 mm was output on 30,000 sheets as two sheets per one job, with the use of a LETTER size of Vitality (LTR 75 g/m²) manufactured by XEROX.

With the use of a portable spectrophotometer Exact Advance (X-Rite), an image density of the solid image 1 was measured at 5 points at 50 mm intervals from the leading edge of the paper in a longitudinal direction from the leading edge to the trailing edge of the paper, in three rows of a center row, a row 20 mm apart from the left edge, and a row 20 mm apart from the right edge, and 15 points in total.

The difference between the average density and the minimum density was determined with the use of the measured density values at the 15 points, and was determined to be the solid density difference after the durability evaluation.

As the toner is more satisfactory in the charge rising property under the low-temperature and low-humidity environment, the solid density difference becomes smaller, and the charge rising property is more satisfactory. Evaluation was performed according to the following criteria.
(Solid density difference after durability evaluation under low-temperature and low-humidity environment)
A. The solid density difference after the durability evaluation is less than 0.05.
B. The solid density difference after the durability evaluation is 0.05 or more and less than 0.10.
C. The solid density difference after the durability evaluation is 0.10 or more and less than 0.15.
D. The solid density difference after the durability evaluation is 0.15 or more.
   <Evaluation 3. Fogging after Durability Evaluation Under Low-Temperature and Low-Humidity Environment>

In the same way as in Evaluation 2, the durability evaluation was performed which output 30,000 sheets of a horizontal line image having a printing rate of 1.5% and a margin of 5 mm, under the low-temperature and low-humidity environment.

After that, paper to which a tag of 5 cm×5 cm was attached at the center of the printing surface of the paper was set in a cassette, and then an all-white image was output as the 30,001 st sheet (all-white image 1).

After the tag on the all-white image 1 was peeled off, the reflectance (%) of the portion on which the tag was attached and the reflectance (%) of the portion on which the tag was not attached were measured with the use of a white light meter TC-6DX (manufactured by Tokyo Denshoku Co., Ltd.); and the difference between both of the reflectances was measured and calculated as fogging (%), and the fogging was evaluated according to the following criteria.
(Fogging after durability evaluation under low-temperature and low-humidity environment)
A. The fogging after durability evaluation is less than 0.5.
B. The fogging after durability evaluation is 0.05 or more and less than 0.10.
C. The fogging after durability evaluation is 1.0 or more and less than 1.5.
D. The fogging after the durability evaluation is 1.5 or more.
   <Evaluation 4. Fogging after Durability Evaluation Under High-Temperature and High-Humidity Environment>

The main body of the printer and the toner cartridge filled with 400 g of an evaluation toner were left to stand in an environment of 32° C. and 80% RH for 24 hours, for the purpose of being adjusted to a temperature and a humidity of the evaluation environment. After the standing, similarly under the high-temperature and high-humidity environment, the durability evaluation was performed in which a horizontal line image having a printing rate of 1.5% and a margin of 5 mm was output on 30,000 sheets as two sheets per one job, with the use of a LETTER size of Vitality (LTR 75 g/m²) manufactured by XEROX.

After that, paper to which a tag of 5 cm×5 cm was attached at the center of the printing surface of the paper was set in a cassette, and then an all-white image was output as the 30,001st sheet (all-white image 1).

After the tag on the all-white image 1 was peeled off, the reflectance (%) of the portion on which the tag was attached and the reflectance (%) of the portion on which the tag was not attached were measured with the use of a white light meter TC-6DX (manufactured by Tokyo Denshoku Co., Ltd.); and the difference between both of the reflectances was measured and calculated as fogging (%), and the fogging was evaluated according to the following criteria.
(Fogging after the durability evaluation under high-temperature and high-humidity environment)
A. The fogging after the durability evaluation is less than 0.5.
B. The fogging after the durability evaluation is 0.5 or more and less than 1.0.
C. The fogging after the durability evaluation is 1.0 or more and less than 1.5.
D. The fogging after the durability evaluation is 1.5 or more.
   <Evaluation 5. Density Uniformity of Solid Image after Standing after Durability Evaluation in Low-Temperature and Low-Humidity Environment>

In the same way as in Evaluation 2, the durability evaluation was performed which output 30,000 sheets of a horizontal line image having a printing rate of 1.5% and a margin of 5 mm, under the low-temperature and low-humidity environment, and then one sheet of an image of entirely solid black was output as the 30,001st sheet (solid image 1).

After that, the printer was left to stand as it was for 3 days, and then, as the 30,002nd sheet, one sheet of the image of the entirely solid black was output (solid image 2).

With the use of a portable spectrophotometer Exact Advance (X-Rite), an image density of the solid image 2 was measured at 5 points at 50 mm intervals from the leading edge of the paper in a longitudinal direction from the leading edge to the trailing edge of the paper, in three rows of a center row, a row 20 mm apart from the left edge, and a row 20 mm apart from the right edge, and 15 points in total.

The difference between the average density and the minimum density was determined with the use of the measured density values at the 15 points, and was determined to be the solid density difference after the standing.

As the toner is more satisfactory in the charge rising property after standing for a long period under the low-temperature and low-humidity environment, the solid density difference becomes smaller, and the charge rising property after the standing is more satisfactory. Evaluation was performed according to the following criteria.
(Solid density difference after standing after durability evaluation in low-temperature and low-humidity environment)
A. The solid density difference after the standing is less than 0.05.
B. The solid density difference after the standing is 0.05 or more and less than 0.10.
C. The solid density difference after the standing is 0.10 or more and less than 0.15.
D. The solid density difference after the standing is 0.15 or more.
   <Evaluation 6. Density Uniformity of Solid Image after Standing after Durability Evaluation Under High-Temperature and High-Humidity Environment>

In the same way as in Evaluation 4, the durability evaluation was performed which output 30,000 sheets of a horizontal line image having a printing rate of 1.5% and a margin of 5 mm, under the high-temperature and high-humidity environment, and then one sheet of an image of entirely solid black was output as the 30,001st sheet (solid image 1).

After that, the printer was left to stand as it was for 3 days, and then, as the 30,002nd sheet, one sheet of the image of the entirely solid black was output (solid image 2).

With the use of a portable spectrophotometer Exact Advance (X-Rite), an image density of the solid image 2 was measured at 5 points at 50 mm intervals from the leading edge of the paper in a longitudinal direction from the leading edge to the trailing edge of the paper, in three rows of a center row, a row 20 mm apart from the left edge, and a row 20 mm apart from the right edge, and 15 points in total.

The difference between the average density and the minimum density was determined with the use of the measured density values at the 15 points, and was determined to be the solid density difference after the standing.

As the toner is more satisfactory in the charge rising property after standing for a long period under the high-temperature and high-humidity environment, the solid density difference becomes smaller, and the charge rising property after the standing is more satisfactory. Evaluation was performed according to the following criteria.
(Solid density difference after standing after durability evaluation under high-temperature and high-humidity environment)
A. The solid density difference after the standing is less than 0.05.
B. The solid density difference after the standing is 0.05 or more and less than 0.10.
C. The solid density difference after the standing is 0.10 or more and less than 0.15.
D. The solid density difference after the standing is 0.15 or more.
   <Evaluation 7. Halftone Density Difference after High-Printing Durability Evaluation Under Low-Temperature and Low-Humidity Environment>

The main body of the printer and the toner cartridge filled with 400 g of an evaluation toner were left to stand in an environment of 15° C. and 10% RH for 24 hours, for the purpose of being adjusted to a temperature and a humidity of the evaluation environment. After the standing, similarly under the low-temperature and low-humidity environment, the durability evaluation was performed in which a halftone image having a printing rate of 23% and a margin of 5 mm was output on 1,300 sheets as two sheets per one job, with the use of a LETTER size of Vitality (LTR 75 g/m²) manufactured by XEROX.

After that, as the 1,301st sheet, a halftone image having a printing rate of 23%, a margin of 23%, and a margin of 5 mm was output on one sheet (halftone image 1).

After that, a charging roller was replaced with a new one, and then a halftone image having a printing rate of 23% was output on one sheet as the 1,302nd sheet (halftone image 2).

With the use of a portable spectrophotometer Exact Advance (X-Rite), image densities of halftone images 1 and 2 were measured at 5 points, at 50 mm intervals from the leading edge of the paper in a longitudinal direction from the leading edge to the trailing edge of the paper, in three rows of a center row, a row 20 mm apart from the left edge, and a row 20 mm apart from the right edge, and 15 points in total, respectively.

The density difference (difference between the maximum value and the minimum value measured at 15 points) was obtained for each of the halftone images 1 and 2, and then the difference between the density difference of the halftone image 1 and the density difference of the halftone image 2 was calculated, and the halftone density difference due to the charging roller contamination after the high-printing durability evaluation was determined.

The halftone images were evaluated according to the following criteria based on the halftone density difference due to the contamination of the charging roller after the high-printing durability evaluation.

In the present invention, in order to improve the halftone density difference due to the contamination of the charging roller after the high-printing durability evaluation, it is preferable to control the amount Z of the fatty acid existing on the surface of the strontium titanate particle to a preferable range. This is because, withing the above described range, the charge relaxation rate of the strontium titanate particle can be enhanced, and the contamination of the charging roller can be suppressed, even in the case where a large number of toners are consumed in a short time as in the high-printing durability evaluation.
(Halftone density difference due to charging roller contamination after high-printing durability evaluation)
A. The halftone density difference is less than 0.05.
B. The halftone density difference is 0.05 or more and less than 0.10.
C. The halftone density difference is 0.10 or more and less than 0.15.
D. The halftone density difference is 0.15 or more.
   <Evaluation 8. Solid Density Uniformity after High-Printing Durability Evaluation Under High-Temperature and High-Humidity Environment>

The main body of the printer and the toner cartridge filled with 400 g of an evaluation toner were left to stand in an environment of 32° C. and 80% RH for 24 hours, for the purpose of being adjusted to a temperature and a humidity of the evaluation environment. After the standing, similarly under the high-temperature and high-humidity environment, the durability evaluation was performed in which a halftone image having a printing rate of 23% and a margin of 5 mm was output on 1,300 sheets as two sheets per one job, with the use of a LETTER size of Vitality (LTR 75 g/m²) manufactured by XEROX.

After that, as the 1,301st sheet, one sheet of the image of the entirely solid black was output (solid image 1).

With the use of a portable spectrophotometer Exact Advance (X-Rite), an image density of the solid image 1 was measured at 5 points at 50 mm intervals from the leading edge of the paper in a longitudinal direction from the leading edge to the trailing edge of the paper, in three rows of a center row, a row 20 mm apart from the left edge, and a row 20 mm apart from the right edge, and 15 points in total.

The difference between the average density and the minimum density was determined with the use of the measured density values at the 15 points, and was determined to be the solid density difference after the high-printing durability evaluation.

As the toner is more satisfactory in the charge rising property after the high-printing durability evaluation under the high-temperature and high-humidity environment, the solid density difference becomes smaller, and the charge rising property after the standing is more satisfactory. Evaluation was performed according to the following criteria.

In the present invention, in order to improve the solid density difference after the high-printing durability evaluation, it is preferable to control the amount Z of the fatty acid existing on the surface of the strontium titanate particle to a preferable range. This is because, within the above described range, the fluidity of the toner containing the strontium titanate particle can be improved, and the charge rising property of the toner can be improved, even in the case where a large number of the toners are consumed in a short time as in the high-printing durability evaluation.
(Solid density difference after high-printing durability evaluation under high-temperature and high-humidity environment)
A. The solid density difference is less than 0.05.
B. The solid density difference is 0.05 or more and less than 0.10.
C. The solid density difference is 0.10 or more and less than 0.15.
D. The solid density difference is 0.15 or more.
   <Evaluation 9. Fogging after High-Printing Durability Evaluation Under High-Temperature and High-Humidity Environment>

In the same way as in Evaluation 8, the durability evaluation was performed in which a halftone image having a printing rate of 23% and a margin of 5 mm was output on 1,300 sheets as two sheets per one job, under the high-temperature and high-humidity environment.

After that, paper to which a tag of 5 cm×5 cm was attached at the center of the printing surface of the paper was set in a cassette, and then an all-white image was output as 1,301st sheet (all-white image 1).

After the tag on the all-white image 1 was peeled off, the reflectance (%) of the portion on which the tag was attached and the reflectance (%) of the portion on which the tag was not attached were measured with the use of a white light meter TC-6DX (manufactured by Tokyo Denshoku Co., Ltd.); and the difference between both of the reflectances was measured and calculated as fogging (%), and the fogging was evaluated according to the following criteria.

In the present invention, in order to improve the fogging after the high-printing durability evaluation under the high-temperature and high-humidity environment, it is preferable to control the number of carbon atoms of the fatty acid existing on the surface of the strontium titanate particle to a preferable range. This is because strontium titanate has sufficient hydrophobicity even under the high-temperature and high-humidity environment, and accordingly, can improve the charge rising property of the toner in a short time period.
(Fogging after high-printing durability evaluation under high-temperature and high-humidity environment)
A. The fogging after the high-printing durability evaluation is less than 0.5.
B. The fogging after the high-printing durability evaluation is 0.5 or more and less than 1.0.
C. The fogging after the high-printing durability evaluation is 1.0 or more and less than 1.5.
D. The fogging after the high-printing durability evaluation is 1.5 or more.
   <Evaluation 10. Fogging after High-Printing Durability Evaluation Under Low-Temperature and Low-Humidity Environment>

In the same way as in Evaluation 7, the durability evaluation was performed which output 1,300 sheets of a halftone image having a printing rate of 23% and a margin of 5 mm as two sheets per one job, under the low-temperature and low-humidity environment.

After that, paper to which a tag of 5 cm×5 cm was attached at the center of the printing surface of the paper was set in a cassette, and then an all-white image was output as 1,301st sheet (all-white image 1).

After the tag on the all-white image 1 was peeled off, the reflectance (%) of the portion on which the tag was attached and the reflectance (%) of the portion on which the tag was not attached were measured with the use of a white light meter TC-6DX (manufactured by Tokyo Denshoku Co., Ltd.); and the difference between both of the reflectances was measured and calculated as fogging (%), and the fogging was evaluated according to the following criteria.
(Fogging after high-printing durability evaluation under low-temperature and low-humidity environment)
A. The fogging after the high-printing durability evaluation is less than 0.5.
B. The fogging after the high-printing durability evaluation is 0.5 or more and less than 1.0.
C. The fogging after the high-printing durability evaluation is 1.0 or more and less than 1.5.
D. The fogging after the high-printing durability evaluation is 1.5 or more.

### <Evaluation 11. Line Width Stability Under Low-Temperature and Low-Humidity Environment>

In the same way as in Evaluation 1, the durability evaluation was performed which output 30,000 sheets of a horizontal line image having a printing rate of 1.5% and a margin of 5 mm as two sheets per one job, under the low-temperature and low-humidity environment.

After that, as the 30,001st sheet, a horizontal line image (horizontal line image 1) was output in which a margin of 5 mm, a horizontal line with a width of 170 μm and a white line with a width of 8.33 mm were repeated.

Then, the line width of the horizontal line image 1 was measured with a loupe at 15 points, and a line width difference was determined as a difference between the maximum value and the minimum value of the line width; and evaluation was performed according to the following criteria.
(Line width stability under low-temperature and low-humidity environment)
A. The line width difference is less than 4 μm.
B. The line width difference is 4 or more and less than 8 μm.
C. The line width difference is 8 or more and less than 12 μm.
D. The line width difference is 12 μm or more.
   <Evaluation 12. Fogging after Low-Printing Continuous Durability Evaluation Under Low-Temperature and Low-Humidity Environment>

In the same way as in Evaluation 1, the durability evaluation was performed which output a horizontal line image having a printing rate of 0.5% and a margin of 5 mm, on 5,000 sheets in total as 500 sheets per one job, under the low-temperature and low-humidity environment.

After that, 101 sheets of paper in total of 100 sheets of paper and 1 sheet of paper to which a tag of 5 cm×5 cm was attached at the center of the printing surface of the paper were set in a cassette.

Then, a printing mode was set in which 101 sheets were continuously output in one job, and 100 sheets of a horizontal line image having a printing rate of 0.5% and a margin of 5 mm were output as prints from the 5,001st sheet to 5,000th sheet, and one sheet of an all-white image was output on paper on which a tag of 5 cm×5 cm was attached to the center portion of the printing surface of the paper, as the 5,101st sheet (all-white image 1).

After that, the tag on the all-white image 1 was peeled off, and then the reflectance (%) of the portion on which the tag was attached and the reflectance (%) of the portion on which the tag was not attached were measured with the use of a white light meter TC-6DX (manufactured by Tokyo Denshoku Co., Ltd.); and the difference between both of the reflectances was measured and calculated as fogging (%), and evaluation was performed according to the following criteria.

When the low-printing continuous durability evaluation has been performed under the low-temperature and low-humidity environment, the charge-up of the toner tends to easily occur; and the charging is broadened, and a strong negative component and/or positive component tend to be easily generated. In the present invention, containing of the titanium oxide particle having the maximum Feret's diameter and the aspect ratio in the preferable ranges is preferred because the fogging after the low-printing continuous durability can be suppressed more satisfactorily.
(Fogging after low-printing continuous durability evaluation under low-temperature and low-humidity environment)
A. The fogging after the durability evaluation is less than 0.5.
B. The fogging after the durability evaluation is 0.5 or more and less than 1.0.
C. The fogging after the durability evaluation is 1.0 or more and less than 1.5.
D. The fogging after the durability evaluation is 1.5 or more.

TABLE 5-1

| | | | | | | | | | | <Evaluation 5> | | <Evaluation 6> | |
|---|---|---|---|---|---|---|---|---|---|---|---|---|---|
| | | <Evaluation 1> | | <Evaluation 2> | | <Evaluation 3> | | <Evaluation 4> | | Solid density | | Solid density | |
| | | Halftone density | | Density uniformity | | Fogging after | | Fogging after | | uniformity after | | uniformity after | |
| | | uniformity after | | of solid image after | | durability | | durability | | 3 days of standing | | 3 days of standing | |
| | | durability under | | durability under | | under low- | | under high- | | after durability | | after durability | |
| | | low-temperature | | low-temperature | | temperature and | | temperature and | | in low-temperature | | in high-temperature | |
| | | and low-humidity | | and low-humidity | | low-humidity | | high-humidity | | and low-humidity | | and high-humidity | |
| Example | Toner No. | environment | | environment | | environment | | environment | | environment | | environment | |
| Example 1 | Toner 1 | A | 0.01 | A | 0.01 | A | 0.1 | A | 0.1 | A | 0.01 | A | 0.01 |
| Example 2 | Toner 2 | A | 0.01 | A | 0.01 | A | 0.1 | A | 0.1 | A | 0.01 | A | 0.01 |
| Example 3 | Toner 3 | A | 0.01 | A | 0.02 | A | 0.1 | A | 0.1 | A | 0.02 | A | 0.02 |
| Example 4 | Toner 4 | A | 0.01 | B | 0.08 | A | 0.1 | A | 0.1 | B | 0.06 | A | 0.02 |
| Example 5 | Toner 5 | A | 0.01 | C | 0.11 | A | 0.1 | A | 0.1 | C | 0.12 | A | 0.02 |
| Example 6 | Toner 6 | A | 0.01 | B | 0.08 | A | 0.1 | A | 0.1 | B | 0.07 | A | 0.02 |
| Example 7 | Toner 7 | A | 0.01 | A | 0.03 | A | 0.1 | A | 0.1 | A | 0.02 | A | 0.02 |
| Example 8 | Toner 8 | A | 0.02 | C | 0.11 | A | 0.1 | A | 0.1 | C | 0.12 | A | 0.02 |
| Example 9 | Toner 9 | A | 0.01 | A | 0.03 | A | 0.1 | A | 0.1 | A | 0.03 | A | 0.02 |
| Example 10 | Toner 10 | A | 0.02 | A | 0.03 | A | 0.1 | A | 0.1 | A | 0.03 | A | 0.02 |
| Example 11 | Toner 11 | A | 0.01 | A | 0.02 | A | 0.1 | A | 0.1 | A | 0.02 | A | 0.02 |
| Example 12 | Toner 12 | A | 0.02 | A | 0.03 | A | 0.1 | A | 0.2 | A | 0.02 | A | 0.03 |
| Example 13 | Toner 13 | A | 0.01 | A | 0.03 | A | 0.1 | A | 0.1 | A | 0.02 | A | 0.02 |
| Example 14 | Toner 14 | A | 0.01 | A | 0.03 | A | 0.1 | A | 0.2 | A | 0.02 | A | 0.02 |
| Example 15 | Toner 15 | A | 0.01 | A | 0.03 | A | 0.1 | A | 0.1 | A | 0.03 | A | 0.02 |
| Example 16 | Toner 16 | A | 0.01 | A | 0.04 | A | 0.1 | A | 0.1 | A | 0.02 | A | 0.02 |
| Example 17 | Toner 17 | A | 0.01 | A | 0.03 | A | 0.1 | A | 0.2 | A | 0.03 | A | 0.03 |
| Example 18 | Toner 18 | A | 0.01 | A | 0.03 | A | 0.1 | A | 0.1 | A | 0.02 | A | 0.02 |
| Example 19 | Toner 19 | A | 0.01 | A | 0.03 | A | 0.1 | A | 0.1 | A | 0.03 | A | 0.02 |
| Example 20 | Toner 20 | A | 0.01 | A | 0.03 | B | 0.6 | A | 0.2 | A | 0.02 | A | 0.02 |
| Example 21 | Toner 21 | A | 0.02 | A | 0.03 | C | 1.0 | A | 0.1 | A | 0.02 | A | 0.02 |
| Example 22 | Toner 22 | A | 0.02 | A | 0.03 | C | 1.0 | A | 0.2 | B | 0.07 | A | 0.02 |
| Example 23 | Toner 23 | A | 0.02 | A | 0.03 | C | 1.1 | A | 0.1 | C | 0.13 | A | 0.02 |
| Example 24 | Toner 24 | A | 0.04 | A | 0.03 | C | 1.1 | A | 0.1 | C | 0.13 | A | 0.03 |
| Example 25 | Toner 25 | B | 0.07 | A | 0.03 | C | 1.1 | A | 0.2 | C | 0.13 | A | 0.02 |

TABLE 5-2

| | | | | | | | | | | <Evaluation 5> | | <Evaluation 6> | |
|---|---|---|---|---|---|---|---|---|---|---|---|---|---|
| | | <Evaluation 1> | | <Evaluation 2> | | <Evaluation 3> | | <Evaluation 4> | | Solid density | | Solid density | |
| | | Halftone density | | Density uniformity | | Fogging after | | Fogging after | | uniformity after | | uniformity after | |
| | | uniformity after | | of solid image after | | durability | | durability | | 3 days of standing | | 3 days of standing | |
| | | durability under | | durability under | | under low- | | under high- | | after durability | | after durability | |
| | | low-temperature | | low-temperature | | temperature and | | temperature and | | in low-temperature | | in high-temperature | |
| | | and low-humidity | | and low-humidity | | low-humidity | | high-humidity | | and low-humidity | | and high-humidity | |
| Example | Toner No. | environment | | environment | | environment | | environment | | environment | | environment | |
| Example 26 | Toner 26 | A | 0.02 | A | 0.03 | A | 0.1 | B | 0.7 | A | 0.02 | A | 0.03 |
| Example 27 | Toner 27 | A | 0.03 | A | 0.03 | A | 0.1 | B | 0.8 | A | 0.02 | B | 0.08 |
| Example 28 | Toner 28 | A | 0.02 | A | 0.03 | A | 0.1 | B | 0.8 | A | 0.02 | C | 0.13 |
| Example 29 | Toner 29 | A | 0.02 | A | 0.03 | A | 0.1 | B | 0.7 | A | 0.02 | A | 0.02 |
| Example 30 | Toner 30 | A | 0.02 | A | 0.03 | A | 0.1 | B | 0.8 | A | 0.02 | A | 0.03 |
| Example 31 | Toner 31 | B | 0.07 | A | 0.03 | A | 0.1 | B | 0.8 | A | 0.03 | B | 0.09 |
| Example 32 | Toner 32 | B | 0.09 | A | 0.03 | A | 0.1 | B | 0.8 | A | 0.02 | B | 0.09 |
| Example 33 | Toner 33 | C | 0.11 | A | 0.03 | A | 0.1 | B | 0.8 | A | 0.03 | B | 0.08 |
| Example 34 | Toner 34 | C | 0.12 | A | 0.03 | A | 0.1 | C | 1.3 | A | 0.02 | B | 0.08 |
| Example 35 | Toner 35 | A | 0.03 | A | 0.03 | A | 0.1 | A | 0.3 | A | 0.02 | A | 0.02 |
| Example 36 | Toner 36 | A | 0.03 | A | 0.03 | A | 0.1 | A | 0.3 | A | 0.02 | A | 0.02 |
| Example 37 | Toner 37 | A | 0.03 | A | 0.03 | A | 0.1 | A | 0.3 | A | 0.02 | A | 0.02 |
| Example 38 | Toner 38 | A | 0.03 | A | 0.03 | A | 0.1 | A | 0.3 | A | 0.02 | A | 0.02 |
| Example 39 | Toner 39 | A | 0.03 | A | 0.03 | B | 0.9 | A | 0.3 | A | 0.03 | A | 0.03 |
| Example 40 | Toner 40 | A | 0.03 | C | 0.12 | A | 0.3 | A | 0.1 | C | 0.13 | A | 0.04 |
| Example 41 | Toner 41 | A | 0.02 | A | 0.04 | A | 0.2 | A | 0.2 | A | 0.04 | A | 0.03 |
| Example 42 | Toner 42 | A | 0.03 | C | 0.12 | B | 0.7 | A | 0.1 | C | 0/13 | A | 0.04 |
| Comparative | Toner 43 | D | 0.20 | C | 0.14 | C | 1.4 | D | 2.1 | C | 0.14 | D | 0.22 |
| example 1 | | | | | | | | | | | | | |
| Comparative | Toner 44 | D | 0.21 | C | 0.14 | C | 1.4 | D | 2.3 | C | 0.14 | D | 0.25 |
| example 2 | | | | | | | | | | | | | |
| Comparative | Toner 45 | C | 0.14 | D | 0.22 | D | 2.1 | D | 2.1 | D | 0.25 | D | 0.29 |
| example 3 | | | | | | | | | | | | | |
| Comparative | Toner 46 | C | 0.14 | D | 0.23 | D | 2.4 | D | 2.6 | D | 0.31 | D | 0.30 |
| example 4 | | | | | | | | | | | | | |
| Comparative | Toner 47 | D | 0.22 | D | 0.25 | D | 2.0 | D | 3.0 | D | 0.24 | D | 0.31 |
| example 5 | | | | | | | | | | | | | |

TABLE 5-3

| | | <Evaluation 7> | | <Evaluation 8> | | | | | | | | <Evaluation 12> | |
|---|---|---|---|---|---|---|---|---|---|---|---|---|---|
| | | Halftone density | | Density uniformity | | <Evaluation 9> | | <Evaluation 10> | | <Evaluation 11> | | Fogging after | |
| | | uniformity after | | of solid image after | | Fogging after | | Fogging after | | Line width | | low-printing | |
| | | high-printing | | high-printing | | high-printing | | high-printing | | uniformity | | continuous | |
| | | durability under | | durability under | | durability under | | durability under | | under low- | | durability under | |
| | | low-temperature | | high-temperature | | high-temperature | | low-temperature | | temperature and | | low-temperature | |
| | | and low-humidity | | and high-humidity | | and high-humidity | | and low-humidity | | low-humidity | | and low-humidity | |
| Example | Toner No. | environment | | environment | | environment | | environment | | environment | | environment | |
| Example 1 | Toner 1 | A | 0.01 | A | 0.01 | A | 0.1 | A | 0.1 | A | 1 | A | 0.2 |
| Example 2 | Toner 2 | A | 0.01 | A | 0.01 | A | 0.1 | A | 0.1 | A | 1 | A | 0.2 |
| Example 3 | Toner 3 | A | 0.01 | A | 0.01 | A | 0.1 | A | 0.1 | B | 5 | A | 0.2 |
| Example 4 | Toner 4 | A | 0.02 | A | 0.02 | A | 0.2 | A | 0.2 | B | 5 | A | 0.2 |
| Example 5 | Toner 5 | A | 0.02 | A | 0.02 | A | 0.2 | A | 0.2 | B | 5 | A | 0.2 |
| Example 6 | Toner 6 | A | 0.02 | A | 0.01 | A | 0.1 | A | 0.2 | B | 5 | A | 0.2 |
| Example 7 | Toner 7 | A | 0.01 | A | 0.01 | A | 0.2 | A | 0.1 | B | 5 | A | 0.2 |
| Example 8 | Toner 8 | A | 0.02 | A | 0.02 | A | 0.2 | A | 0.2 | C | 10 | A | 0.2 |
| Example 9 | Toner 9 | A | 0.01 | A | 0.01 | A | 0.1 | A | 0.1 | C | 11 | A | 0.2 |
| Example 10 | Toner 10 | A | 0.01 | A | 0.01 | A | 0.4 | A | 0.1 | B | 6 | A | 0.2 |
| Example 11 | Toner 11 | A | 0.01 | A | 0.01 | A | 0.1 | A | 0.4 | B | 6 | A | 0.2 |
| Example 12 | Toner 12 | A | 0.01 | A | 0.01 | B | 0.9 | A | 0.2 | B | 7 | A | 0.2 |
| Example 13 | Toner 13 | A | 0.01 | A | 0.01 | A | 0.1 | B | 0.5 | B | 7 | A | 0.2 |
| Example 14 | Toner 14 | A | 0.01 | A | 0.01 | A | 0.2 | A | 0.2 | B | 6 | A | 0.2 |
| Example 15 | Toner 15 | A | 0.01 | A | 0.01 | A | 0.1 | A | 0.1 | B | 7 | A | 0.2 |
| Example 16 | Toner 16 | A | 0.01 | B | 0.08 | A | 0.2 | A | 0.2 | B | 6 | A | 0.2 |
| Example 17 | Toner 17 | A | 0.01 | C | 0.13 | A | 0.1 | A | 0.1 | B | 7 | A | 0.2 |
| Example 18 | Toner 18 | B | 0.08 | A | 0.02 | A | 0.1 | A | 0.1 | B | 6 | A | 0.2 |
| Example 19 | Toner 19 | C | 0.13 | A | 0.03 | A | 0.2 | A | 0.1 | B | 6 | A | 0.2 |
| Example 20 | Toner 20 | A | 0.02 | A | 0.02 | A | 0.1 | A | 0.2 | B | 6 | A | 0.2 |
| Example 21 | Toner 21 | A | 0.02 | A | 0.03 | A | 0.1 | A | 0.1 | B | 7 | A | 0.4 |
| Example 22 | Toner 22 | A | 0.02 | A | 0.03 | A | 0.2 | A | 0.1 | B | 6 | A | 0.4 |
| Example 23 | Toner 23 | A | 0.02 | A | 0.03 | A | 0.2 | A | 0.1 | B | 7 | A | 0.4 |
| Example 24 | Toner 24 | A | 0.02 | A | 0.03 | A | 0.1 | A | 0.1 | B | 6 | A | 0.4 |
| Example 25 | Toner 25 | B | 0.08 | A | 0.03 | A | 0.2 | A | 0.1 | B | 5 | A | 0.4 |

TABLE 5-4

| | | <Evaluation 7> | | <Evaluation 8> | | | | | | | | <Evaluation 12> | |
|---|---|---|---|---|---|---|---|---|---|---|---|---|---|
| | | Halftone density | | Density uniformity | | <Evaluation 9> | | <Evaluation 10> | | <Evaluation 11> | | Fogging after | |
| | | uniformity after | | of solid image after | | Fogging after | | Fogging after | | Line width | | low-printing | |
| | | high-printing | | high-printing | | high-printing | | high-printing | | uniformity | | continuous | |
| | | durability under | | durability under | | durability under | | durability under | | under low- | | durability under | |
| | | low-temperature | | high-temperature | | high-temperature | | low-temperature | | temperature and | | low-temperature | |
| | | and low-humidity | | and high-humidity | | and high-humidity | | and low-humidity | | low-humidity | | and low-humidity | |
| Example | Toner No. | environment | | environment | | environment | | environment | | environment | | environment | |
| Example 26 | Toner 26 | A | 0.02 | A | 0.03 | A | 0.1 | A | 0.1 | B | 7 | A | 0.2 |
| Example 27 | Toner 27 | A | 0.03 | A | 0.03 | A | 0.1 | A | 0.1 | B | 6 | A | 0.2 |
| Example 28 | Toner 28 | A | 0.04 | A | 0.03 | A | 0.1 | A | 0.2 | B | 5 | A | 0.2 |
| Example 29 | Toner 29 | A | 0.02 | B | 0.08 | A | 0.1 | A | 0.1 | B | 6 | A | 0.2 |
| Example 30 | Toner 30 | A | 0.02 | C | 0.12 | A | 0.1 | A | 0.1 | B | 5 | A | 0.2 |
| Example 31 | Toner 31 | C | 0.12 | C | 0.14 | A | 0.1 | A | 0.1 | B | 7 | A | 0.2 |
| Example 32 | Toner 32 | C | 0.12 | C | 0.13 | A | 0.1 | A | 0.2 | B | 6 | A | 0.2 |
| Example 33 | Toner 33 | C | 0.13 | C | 0.13 | A | 0.1 | A | 0.1 | B | 7 | A | 0.2 |
| Example 34 | Toner 34 | C | 0.13 | C | 0.13 | A | 0.1 | A | 0.2 | B | 6 | A | 0.2 |
| Example 35 | Toner 35 | A | 0.03 | A | 0.03 | A | 0.1 | B | 0.6 | B | 5 | A | 0.2 |
| Example 36 | Toner 36 | A | 0.03 | A | 0.03 | A | 0.1 | B | 0.6 | B | 5 | A | 0.2 |
| Example 37 | Toner 37 | A | 0.03 | A | 0.03 | A | 0.1 | B | 0.6 | B | 5 | B | 0.7 |
| Example 38 | Toner 38 | A | 0.03 | A | 0.03 | A | 0.1 | B | 0.6 | B | 5 | B | 0.7 |
| Example 39 | Toner 39 | A | 0.03 | A | 0.03 | A | 0.1 | B | 0.8 | B | 7 | C | 1.2 |
| Example 40 | Toner 40 | A | 0.03 | A | 0.03 | A | 0.3 | A | 0.3 | C | 11 | A | 0.3 |
| Example 41 | Toner 41 | A | 0.02 | A | 0.02 | A | 0.2 | A | 0.2 | C | 11 | A | 0.3 |
| Example 42 | Toner 42 | A | 0.03 | A | 0.03 | A | 0.3 | C | 1.1 | C | 11 | B | 0.9 |
| Comparative | Toner 43 | C | 0.14 | D | 0.25 | D | 2.8 | C | 1.4 | D | 15 | D | 2.1 |
| example 1 | | | | | | | | | | | | | |
| Comparative | Toner 44 | C | 0.14 | D | 0.23 | D | 2.7 | C | 1.4 | D | 16 | D | 2.4 |
| example 2 | | | | | | | | | | | | | |
| Comparative | Toner 45 | D | 0.29 | D | 0.28 | D | 2.9 | D | 2.9 | D | 17 | D | 2.3 |
| example 3 | | | | | | | | | | | | | |
| Comparative | Toner 46 | D | 0.31 | D | 0.24 | D | 3.1 | D | 3.3 | D | 17 | D | 2.4 |
| example 4 | | | | | | | | | | | | | |
| Comparative | Toner 47 | D | 0.33 | D | 0.26 | D | 3.0 | D | 3.2 | D | 18 | D | 2.4 |
| example 5 | | | | | | | | | | | | | |

According to the present invention, a toner can be provided that is satisfactory in the charge rising property of the toner and contamination resistance of the charging roller, and a toner can be provided that even when having been subjected to the long-term durable use in the low-temperature and low-humidity environment, can output an image having high density uniformity of a solid image and also having high uniformity of a halftone image.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-010018, filed Jan. 26, 2023, which is hereby incorporated by reference herein in its entirety.

What is claimed is:

1. A toner comprising: a toner particle comprising a binder resin; and a strontium titanate particle, wherein
in TOF-SIMS measurement of the toner particle, a fragment peak derived from a boron atom and a fragment peak derived from a boron-oxygen structure are detected, and
a fatty acid exists on a surface of the strontium titanate particle.

2. The toner according to claim 1, wherein
an abundance (based on mass) of boron atoms in the toner measured by an inductively coupled plasma mass spectrometry apparatus (ICP-MS) is from 0.1 to 100 ppm.

3. The toner according to claim 2, wherein
when the abundance (based on mass) of boron atoms in the toner is represented by X (ppm), and a content of the strontium titanate particle in the toner is represented by Y (% by mass), the X and the Y satisfy the following Expression:
0.10≤X/Y≤30.0.

4. The toner according to claim 2, wherein
when the abundance (based on mass) of boron atoms in the toner is represented by X (ppm), and a content of a fatty acid having from 12 to 30 carbon atoms existing on the surface of the strontium titanate particle is represented by Z (% by mass), the X and the Z satisfy the following Expression:
0.020≤X/Z≤15.0.

5. The toner according to claim 4, wherein the Z is from 0.10 to 5.0.

6. The toner according to claim 1, wherein the fatty acid has from 12 to 30 carbon atoms.

7. The toner according to claim 1, wherein two fatty acids having different numbers of carbon atoms exist on the surface of the strontium titanate particle, the numbers of carbon atoms of the two fatty acids are both from 12 to 30, and the difference in the number of carbon atoms between the two fatty acids is 2 or more.

8. The toner according to claim 1, wherein an average circularity of the toner is from 0.960 to 0.990.

9. The toner according to claim 1, further comprising a titanium oxide particle satisfying the following (i) and (ii), in addition to the strontium titanate particle:
(i) a maximum Feret's diameter is from 300 to 3000 nm; and
(ii) an aspect ratio is 5.0 or larger.
